(19) United States
(12) Patent Application Publication
(10) Pub. No.: US 2016/0364397 A1
(43) Pub. Date: Dec. 15, 2016

(54) System and Methods for Locally Customizing Media Content for Rendering

(71) Applicant: QUALCOMM Incorporated, San Diego, CA (US)

(72) Inventors: Mark Aaron Lindner, Broomfield, CO (US); Shane Dewing, San Diego, CA (US); Rahul Sachdev, San Diego, CA (US)

(21) Appl. No.: 14/736,392

(22) Filed: Jun. 11, 2015

(51) Int. Cl. G06F 17/30; G06F 17/24; G06F 17/27; H04L 29/06; H04L 29/08

(52) U.S. Cl. CPC G06F 17/3089; H04L 65/604; H04L 67/306; G06F 17/2705; G06F 17/30864; G06F 17/3053; G06F 17/24

(57) ABSTRACT

Systems, methods and devices process received media content to generate personalized media presentations on an end point device. Received media content may be buffered in a moving window buffer, and processed to create tokens by parsing a next content element, and, for each content element, identifying a speaker or actor, creating a text representation, and measuring perceptual properties such as pitch, timbre, volume, timing, and frame rate. The end point device may compare a segment of tokens within buffered media content to a list of replacement subject matter within a user profile to determine whether the segment matches any of the replacement subject matter, and identify substitute subject matter for the matched replacement subject matter. The end point device may create a replacement sequence by modifying the substitute subject matter using the perceptual properties of the tokens in the segment, and render a personalized media presentation including the replacement sequence.

### BACKGROUND

Currently, wireless communication and other end point devices can be configured to receive and output a variety of media content to users, including but not limited to, live coverage of sports events, television series, movies, streaming music, informational programs, etc. Conventionally, audio and/or video data is sent to a user device by one or more service providers using broadcast communication links or other network connections. While a user can have broad control over which media content to consume, including selections based on preset preferences/profiles, the selected content is broadcast in a single format (e.g., program, movie, etc.) that does not provide the opportunity for personalization by the user. Some service providers are able to deliver more than one version of a media content item that has been modified for a specific purpose (e.g., to comply with age-appropriateness standards, etc.). However, such versions are traditionally pre-recorded alternatives that are similarly inflexible with respect to personalization to the user. Moreover, while some services involve targeting broadcast media content based on user demographics, the targeting typically only allows for categorizing existing content by broad groupings, without allowing for specific customization of the content itself.

### SUMMARY

The systems, methods, and devices of the various embodiments enable processing received media content to generate a personalized presentation on an end point device by buffering the received media content in a moving window buffer, creating tokens from the received media content, and comparing tokens in a segment within the buffered media content to a list of replacement subject matter associated with a user profile to determine whether the segment matches any of the replacement subject matter. In some embodiments, creating tokens from the received media content may include parsing a next content element, and for each content element, identifying a speaker or actor, creating a text representation, and measuring perceptual properties. In some embodiments, the perceptual properties may include at least one of pitch, timbre, volume, timing, and frame rate. Embodiment methods may also include, identifying substitute subject matter for the matched replacement subject matter in response to determining that the segment matches any of the replacement subject matter, and determining whether a replacement database contains any of the identified substitute subject matter. Embodiment methods may also include, selecting a best substitute subject matter based on properties of the tokens in the segment in response to determining that the replacement database contains any of the identified substitute subject matter, and creating a replacement sequence by modifying the selected best substitute subject matter using the perceptual properties of the tokens in the segment. Embodiment methods may also include integrating the replacement sequence with the buffered media content for the user profile, and rendering a personalized media presentation corresponding to the user profile in which the personalized media presentation includes the integrated replacement sequence.

Embodiment methods may also include synthesizing the replacement sequence based on the identified substitute subject matter and the perceptual properties of the tokens in the segment in response to determining that the segment does not match any of the replacement subject matter. Embodiment methods may also include storing in the replacement database each token that is created by maintaining a local copy of the parsed content element with the corresponding speaker or actor, text representation, and perceptual properties, in which the replacement database is dynamically developed from the received media content.

Embodiment methods may also include comparing each created token or segment of tokens to a list of target subject matter associated with the user profile or with the received media content to determine whether the token or segment comprising tokens matches any of the target subject matter, and storing the token or segment of tokens in the replacement database in response to determining that the token or segment matches any of the target subject matter.

In some embodiments, the list of target subject matter may include at least one of a list of the substitute subject matter generated by a user and associated with a type of audience, and a list of significant attributes, phrases, or scenes associated with the received media content. In some embodiments, selecting the best substitute subject matter may be based on at least one of the perceptual properties of the tokens in the segment, and a pre-set ranking selected by a user of the end point device.

In some embodiments, the content elements may include at least one of phonemes, words, phrases, sentences, scenes, and frames. In some embodiments, Creating tokens from the received media content may include creating tokens from an audio stream, and creating the text representation for each content element may include applying speech-to-text conversion to the content element. In some embodiments, creating tokens from the received media content may include creating tokens from a video stream, and creating the text representation for each content element by applying object recognition to the content element, thereby generating a description of recognized objects in the content element. In some embodiments, determining whether the segment matches any of the replacement subject matter based on at least one of the text representations for tokens within the segment, and the identified speaker or actor for tokens within the segment.

Embodiment methods may also include recognizing an audience viewing or hearing the rendered media, and selecting a user profile corresponding to the recognized audience viewing or hearing the rendered media, in which the list of replacement subject matter is based on the selected user profile. In some embodiments, identifying the speaker or actor may include retrieving, from metadata of the received media content, an identification of a title for the received media content, accessing at least one third party database, and searching the at least one third party database based on the retrieved title. Embodiment methods may also include accessing at least one media database to identify content sources for the identified speaker or actor, searching the at least one media database for samples of the identified content sources, and creating supplemental tokens corresponding to the identified speaker or actor by applying a voice or image recognition to the samples, parsing content elements from the recognized samples, and creating text representations and measuring perceptual properties of the parsed content elements, in which the supplemental tokens are stored in the replacement database such that the stored supplemental tokens are associated with the identified speaker or actor.

Various embodiments may include a wireless communication device and/or other end point device configured to access media content from a media source, and a processor configured with processor-executable instructions to perform operations of the methods described above. Various embodiments also include a non-transitory processor-readable medium on which are stored processor-executable instructions configured to cause a processor of a wireless communication device to perform operations of the methods described above. Various embodiments also include a wireless communication device having means for performing functions of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with various embodiments.

FIG. 2 is a block diagram illustrating a wireless communications device according to various embodiments.

FIGS. 3A and 3B are block diagrams illustrating media content flows in example system configurations according to an embodiment.

FIG. 4 is a process flow diagram illustrating an embodiment method for locally customizing media content for rendering by a wireless communication device according to various embodiments.

FIGS. 5A and 5B are process flow diagrams illustrating an example method for performing pre-rendering processing of audio data as part of the customization implemented in FIG. 4.

FIGS. 6A and 6B are process flow diagrams illustrating an example method for performing pre-rendering processing of video data as part of the customization implemented in FIG. 4.

FIG. 7 is a process flow diagram illustrating an example method for creating and/or integrating a replacement sequence as part of the pre-rendering processing of audio data implemented in FIG. 5B.

FIG. 8 is a component block diagram of an example wireless communication device suitable for use with various embodiments.

FIG. 9 is a component block diagram of another example wireless communication device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The systems, methods, and devices of the various embodiments enable processing received media content to generate a personalized presentation on an end point device by buffering the received media content in a moving window buffer, creating tokens from the received media content, and comparing a segment of tokens within the buffered media content to a list of replacement subject matter associated with a user profile to determine whether the segment matches any of the replacement subject matter. In some embodiments, creating tokens from the received media content may include parsing a next content element, and for each content element, identifying a speaker, actor, object, and/or event, creating a text representation, and measuring perceptual properties. In some embodiments, the perceptual properties may include at least one of a variety of acoustic characteristics of the voice of the identified speaker or actor, for example, pitch, timbre, volume, and tempo. In some embodiments, the perceptual properties may include one or more acoustic characteristic of the audio data without regard to an actor or speaker. In some embodiments the perceptual properties may include at least one of a variety of visual characteristics of a scene, for example, measurements of frame rate, content-based motion (i.e., motion of a three-dimensional object in a scene), egomotion (i.e., motion of the camera based on an image sequence), optical flow (i.e., motion of a three-dimensional object relative to an image plane), etc. Other visual perceptual properties may include values assigned to quantify lighting, color(s), texture(s), topological features, pose estimations, etc.

Embodiment methods may also include, identifying substitute subject matter for the matched replacement subject matter in response to determining that the segment matches any of the replacement subject matter, and determining whether a replacement database contains any of the identified substitute subject matter. Embodiment methods may also include, selecting a best substitute subject matter based on properties of the tokens in the segment in response to determining that the replacement database contains any of the identified substitute subject matter, and creating a replacement sequence by modifying the selected best substitute subject matter using the perceptual properties of the tokens in the segment. Embodiment methods may also include integrating the replacement sequence with the buffered media content for the user profile, and rendering a personalized media presentation corresponding to the user profile in which the personalized media presentation includes the integrated replacement sequence.

As used herein, the terms “wireless communication device,” “wireless device,” “end point device,” “mobile device,” and “rendering device” refer to any one or all of cellular telephones, tablet computers, personal data assistants (PDAs), palm-top computers, notebook computers, laptop computers, personal computers, wireless electronic mail receivers and cellular telephone receivers (e.g., the Blackberry® and Treo® devices), multimedia Internet enabled cellular telephones (e.g., Blackberry Storm®), multimedia enabled smart phones (e.g., Android® and Apple iPhone®), and similar electronic devices that include a programmable processor, memory, a communication transceiver, and a display.

The terms “media content,” “audio/visual data,” “audio/video stream,” and “media presentation,” and “program” are used interchangeably herein to refer to a stream of digital data that is configured for transmission to one or more wireless devices for viewing and/or listening. The media content herein may be received from a service provider or content program provider via a broadcast, multicast, or unicast transmission. Examples of media content may include songs, radio talk show programs, movies, television shows, etc. While media, content received in some embodiments may be streaming live, alternatively or additionally the media content may include prerecorded audio/video data. In some embodiments, the media content may be MPEG (Moving Pictures Expert Group) compliant compressed video or audio data, and may include any of a number of packets, files, frames, and/or clips.

As used herein, the term “server” refers to any computing device capable of functioning as a server, such as a master exchange server, web server, mail server, document server, or any other type of server. A server may be a dedicated computing device or a computing device including a server module (e.g., running an application which may cause the computing device to operate as a server).

In various embodiments replacement content sequences may be designed to target a specific user or group of users for which the personalized media content is intended or personalized. While a group of users may refer to multiple specific users, the term “group of users” may be used to refer to a more generic audience, which may include any of a number of users that fit a particular demographic or other criteria values

In the various embodiments, the presentation of media content modifications may be controlled and individualized by receiving the original media content from a provider at an end point device, and performing pre-rendering processing of the media content by the end point device to make alterations according to a user profile in order to generate a personalized media presentation. The pre-rendering processing may include replacing individual units of the audio and/or video data in the media content based on appropriateness or desirability as determined by the end point device applying a user-specified list of replacement subject matter. In particular, for audio data, the end point device may parse individual words, phrases or sentences that are spoken with a buffered portion of the received media content, measure auditory perception properties associated with the parsed words, phrases or sentences, generate text strings based on the words, phrases, or sentences, compare the text strings to user-specified replacement subject matter, and when there is a match, evaluate the parsed units for replacement candidate audio data. For video data, the end point device may parse individual scenes, images, or frames from a buffered portion of the received media content, measure visual perception properties for the parsed scenes, images, or frames, generate video segments based on the scenes, images or frames, compare the video segments to user-specified replacement subject matter, and when there is a match, evaluate the parsed units for replacement candidate video data. When replacement candidates are found in the audio or video data, a static or dynamic database may be used to retrieve suitable substitutes, which may be adjusted to match the measured auditory or visual perception properties of the units being replaced. In various embodiments, the suitable substitutes may be stored in memory or other retrievable location (e.g., an SD card).

In various embodiments, the media content to be presented by the wireless device is received as a digital broadcast stream via a connection to a network, such as a cellular telephone network, local area network (LAN) or wireless LAN (WLAN) network, WiMAX network, terrestrial network, satellite network, etc., and/or other well known technologies. Such networks may be accessed via any of a number of wireless and/or wired connections, including through a radio frequency (RF) resource, wireless adapter, coaxial cable, fiber optic wires, Digital Subscriber Line (DSL) interface, or an Integrated Service Digital Network (ISDN) interface. In some embodiments, the received media content may be content read from a storage media (e.g., compact disk (CD), a digital video disk (DVD), flash drive, etc.). In some embodiments, the received media content may be encoded using MPEG standards. For example, the received media content may be an MPEG transport stream that includes IP packets with video and audio data. In some embodiments, metadata may be included with the received media content, containing information such as a title or other identifier for the audio/visual presentation provided by the media content.

The wireless device may have stored a number of pre-selected preferences that make up one or more user profiles. In some embodiments, a user profile may be programmed by or for a user or group of users according to individual desirability. For example, a user may create a profile or select a profile defined by a list of selected replacement subject matter (e.g., audio or visual references to events or places disliked by the user or group, particular speakers or actors, etc.) and a corresponding list of substitute subject matter that provides at least one designated alternative to the replacement subject matter (e.g., events or places favored by the user or group, preferred speakers or actors, etc.).

In other embodiments, the pre-selected preferences that make up user profiles may involve combinations of various personalization criteria, such as certain demographics (e.g., gender, age, geographic location, etc.), subject matter preferences, etc. For example, one user profile may be programmed for children under the age of 12 in which the personalization criteria may define a list of inappropriate language and/or violent images as replacement subject matter, and a list of corresponding age-appropriate substitute subject matter. In some embodiments, preferred subject matter may be given high priority in the list of age-appropriate substitute subject matter. As another example, a user profile may be programmed for men located within a geographic distance of Washington, D.C. In this example, replacement subject matter may be certain advertising slogans or logos related to a sport (e.g., professional baseball), and corresponding substitute subject matter may be a list of home team-specific advertising slogans or logos (e.g., Washington Nationals). In such embodiments, multiple personalization criteria may be involved in defining the replacement subject matter. For example, instead of providing only the list of words, phrases, or images to be replaced, the personalization criteria may provide a list of words, phrases, or images that are to be replaced only if a particular speaker, actor, object, or event is identified (or not identified). In this manner, multiple context-dependent customizations may be developed for a single user profile. The replacement subject matter may be based on multiple auditory criteria, multiple visual criteria, and/or a combination of both audio and visual criteria.

In some embodiments, a user profile may list more than one substitute subject matter associated with the same replacement subject matter. For example, for a particular advertising slogan or logo relating to professional baseball above, the above example user profile may list a first corresponding substitute subject matter (i.e., an advertising slogan or logo for Washington Nationals), as well as a second corresponding substitute subject matter (i.e., an advertising slogan or logo for the Baltimore Orioles). In some embodiments, such substitute subject matter may be ranked based on priority, thereby directing the order in which the wireless device will select matching entries in the replacement database. The priority may be pre-programmed by a user customizing the user profile, or may be selected automatically based on preferences associated with the user profile. For example, a wireless device implementing a user profile defined at least in part by geographic location may be configured to automatically prioritize as the “best” the substitute subject matter related to that location, with rankings decreasing based on distance of other locations to which the substitute subject matter relates.

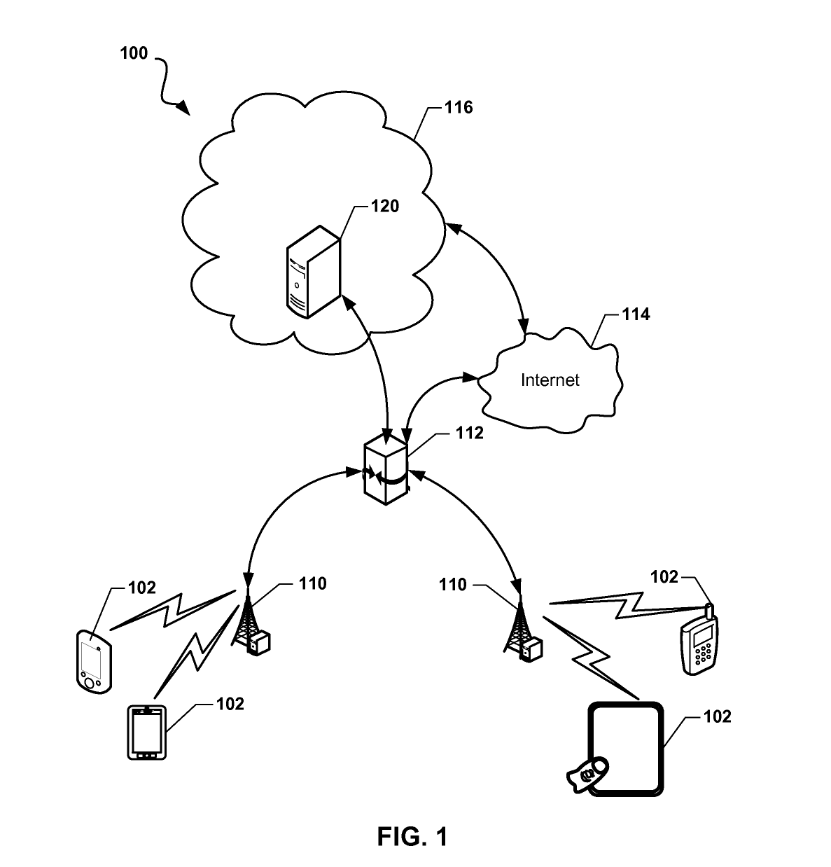

The various embodiments may be implemented within a variety of wireless communication systems 100, an example of which is illustrated in FIG. 1. The communication system 100 may include a plurality of wireless communication devices 102, which may be configured to communicate via cellular telephone network, a radio access network, WiFi network, WiMAX network, and/or other well known technologies. Wireless devices 102 may be configured to receive and transmit voice, data and control signals to and from a base station 110 (e.g., base transceiver station) which may be coupled to a controller (e.g., cellular base station, radio network controller, service gateway, etc.) operable to communicate the voice, data, and control signals between wireless devices 102 and to other network destinations. The base station 110 may communicate with an access gateway 112, which may be a packet data serving node (PDSN), for example, and which may serve as the primary point of entry and exit of wireless device traffic. The access gateway 112 may be implemented in a single computing device or in many computing devices, either within a single network or across a wide area network, such as the Internet.

The access gateway 112 may forward the voice, data, and control signals to network components as user data packets, provide connectivity to external data sources/networks, manage and store network/internal routing information, and act as an anchor between different technologies (e.g., 3G and 4G systems). The access gateway 112 may also coordinate the transmission and reception of data to and from the Internet 114, and the transmission and reception of voice, data and control information to and from an external service network connected to the Internet 114 and other base stations 110.

The access gateway 112 may connect the wireless devices 102 to a service network 116. The service network 116 may control a number of services for individual subscribers, such as management of billing data and selective transmission of data, such as multimedia data, to a specific wireless device 102. The service network 116 may be implemented in a single computing device or in many computing devices, either within a single network or across a wide area network, such as the Internet 114. The service network 116 may typically include one or more servers 120, such as a media server of a content provider, a communication server, etc. The wireless device 102 may be, for example, a smartphone, a tablet computer, a cellular telephone, or any other suitable end point device capable of rendering media content. In general, the wireless devices may include a platform that can receive and execute software applications, data and/or commands transmitted over the wireless network that may ultimately come from the service network 116, the Internet 114 and/or other remote servers and networks.

While the various embodiments are particularly useful with wireless networks, the embodiments are not limited to wireless networks and may also be implemented over wired networks with no changes to the methods.

In the various embodiments, a wireless communication device may receive or access an original audio/video data stream, and may separately process the audio and video data. Such separate processing may involve editing audio data, editing video data, or editing both the audio and video data. In the various embodiments, the processed audio and video data may be re-synchronized (e.g., by use of a buffer or by a time offset in received audio/video streams), and rendered for the intended user or group.

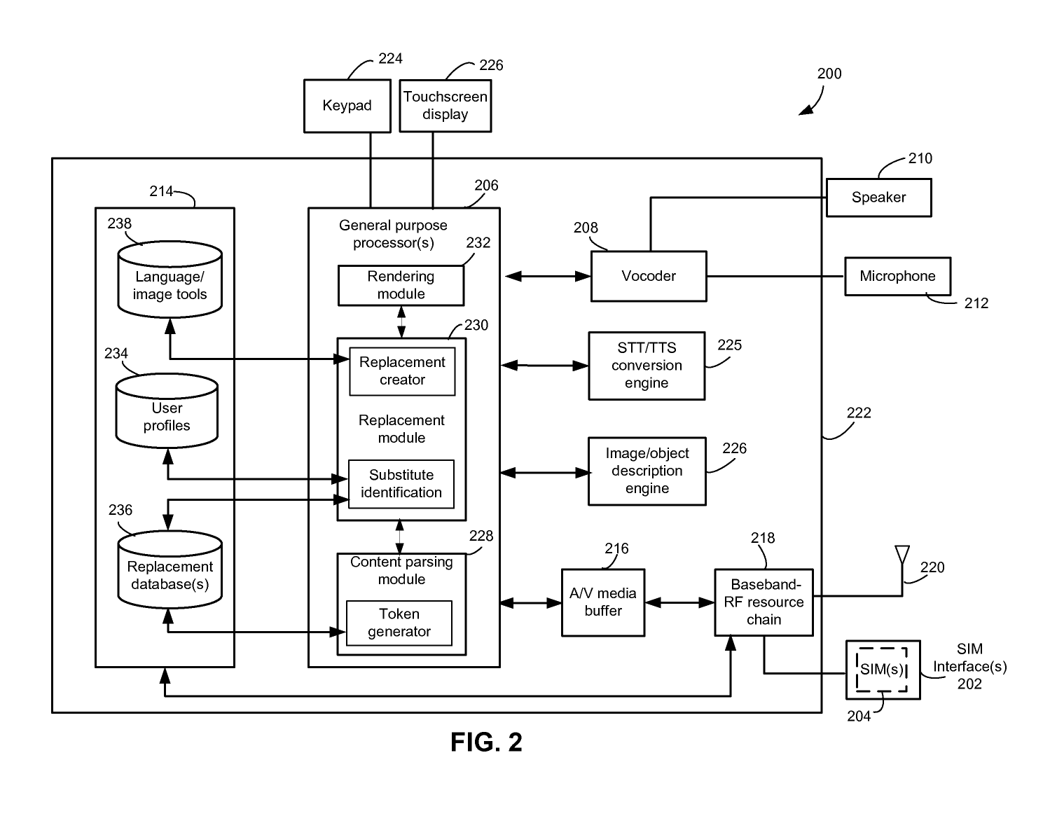

FIG. 2 is a functional block diagram of an example wireless communication device 200 that is suitable for implementing various embodiments. According to various embodiments, the wireless device 200 may be similar to one or more of the wireless devices 102 described with reference to FIG. 1. In various embodiments, the wireless device 200 may be a single-SIM device, or a multi-SIM device, such as a dual-SIM device. In an example, the wireless device 200 may be a dual-SIM dual-active (DSDA) device or a dual-SIM dual-standby (DSDS) device. The wireless device 200 may include at least one SIM interface 202, which may receive at least one SIM 204 that is associated with at least a first subscription. In some embodiments, the at least one SIM interface 202 may be implemented as multiple SIM interfaces 202, which may receive at least two SIMs 204 (e.g., a first SIM (SIM-1) and a second SIM (SIM-2)) respectively associated with at least a first and a second subscription.

The wireless device 200 may include at least one controller, such as a general purpose processor 206, which may be coupled to an audio coder/decoder (CODEC), such as a vocoder 208. The vocoder 208 may in turn be coupled to a speaker 210 and a microphone 212. In an embodiment, the general purpose processor 206 may be coupled to a speech-to-text (STT) and text-to-speech (TTS) conversion engine 225. In some embodiments, the STT and TTS conversion functions may be implemented as physically or logically separate components, while in others they may be implemented in an integrated component (STT/TTS conversion engine 225). In various embodiments, the STT/TTS conversion engine 225 may convert speech (i.e., voice stream) into text, and convert text into speech. In some embodiments, the vocoder 208, which may include a voice synthesizer component to produce speech signals simulating a human voice, may be coupled to the STT/TTS conversion engine 225. In some embodiments, the voice synthesizer component may be integrated with the TTS conversion functions of the STT/TTS conversion engine 225. In addition, the STT/TTS conversion engine 225, and/or the vocoder 208 may be integrated into a single module, unit, component, or software.

The STT/TTS conversion engine 225, vocoder 228, and voice synthesizer may be implemented on a multi-SIM wireless device 200 as software modules in an application executed on an application processor and/or digital signal processor (DSP), as hardware modules (e.g., hardware components hard wired to perform such functions), or as combinations of hardware components and software modules executing on one or more device processors.

In some embodiments, the general processor 206 may also be coupled to an image/object description engine 226, which may recognize and create a text representation of properties describing a tokenized image or scene. Further, the image/object description engine 226 may be configured to recreate images and/or scene data from text representations of their properties.

The various functions of the general purpose processor 206 may be implemented in multiple corresponding components, modules and/or engines of the general purpose processor 206. For example, a content parsing module 228 may be configured to perform pre-rendering processing on individual elements extracted from buffered incoming audio data and/or video data. In some embodiments, the pre-rendering processing that is part of the content parsing module 228 may be implemented in part by a token generator. The token generator may obtain information (e.g., speaker/actor, text representation, and perceptual properties) describing each extracted individual element, thereby creating “tokens” (i.e., the extracted elements and associated information).

In some embodiments, the functions of the content parsing module 228 may include accessing speaker and/or facial recognition logic in order to identify speakers/actors of content elements to generate the tokens. The functions of the content parsing module 228 may include accessing the speech-to-text conversion logic (e.g., from the STT/TTS conversion engine 225), and/or image/object description logic 226 in order to generate text representations of content elements for creating the tokens. Further, the functions of the content parsing module 228 may include accessing digital audio processing and/or video motion detection logic in order to measure perceptual properties of content elements for generating the tokens.

The general processor 206 may also include a replacement module 230 to identify replacement subject matter in segments of the buffered audio and/or visual data using the generated tokens. The replacement module 230 may implement replacement functions in a substitute identifier and a replacement creator. The substitute identifier may identify appropriate substitute subject matter for each replacement subject matter, and the replacement creator may generate a replacement sequence using, for example, identified substitute subject matter (if available) or newly created content, and properties of the tokens in the segment. The general processor 206 may also include a rendering module 232 that may prepare personalized media content for presentation (e.g., integrating edited audio data or an original buffered audio stream with edited video data or an original buffered video stream).

The content parsing module 228, replacement module 230, and rendering module 232 may be software or firmware modules executing in the general purpose processor 206 (or another processor within the device). The general purpose processor 206 may also be coupled to at least one memory 214. The memory 214 may be a non-transitory tangible computer readable storage medium that stores processor-executable instructions. For example, the instructions may include routing received media though a network interface and data buffer for pre-rendering processing. The memory 214 may be a non-transitory memory that stores the operating system (OS), as well as user application software and executable instructions, including processor-executable instruction implementing methods of the various embodiments. The memory 214 may also contain databases or other storage repositories configured to maintain information that may be used by the general purpose processor 206 for pre-rendering processing. Such databases may include a user profile database 234, which may be configured to receive and store user profiles that are each defined by a combination of pre-selected preference settings, personalization criteria, and a look-up table or index listing replacement subject matter and correlated substitute subject matter as discussed in further detail below.

The databases may also include a replacement database 236, which may be configured to receive and store substitute subject matter that can be used to generate appropriate replacement sequences in modifying the audio and/or video data. In some embodiments, a source of the substitute subject matter in the replacement database 236 may be the tokens created from received media content. That is, as the tokens are created from the buffered received media content, some or all may be stored, thereby dynamically developing a comprehensive repository of replacement content. In some embodiments, samples of media content obtained from third party sources may provide additional sources of the substitute subject matter in the replacement database 236.

In some embodiments, the replacement database 236 may be multiple databases, each corresponding to a different speaker or actor identified as the tokens are created. In other embodiments, the substitute subject matter may be organized in a single replacement database 236 based on the identified speaker or actor in each entry. The databases may further include a collection of data for various language and/or image tools.

The language/image tool database 238 may include data useful for creating a replacement sequence from substitute subject matter, such as scripts/extensions that can modify perception properties for the tokens in the segment. The language/image tool database 238 may also include data that is useful for creating audio and/or video content when no substitute subject matter exists on the device. For example, the database 238 may include language and/or voice synthesis data that may be used by the text-to-speech conversion engine to synthesize a base sequence in developing a replacement sequence for the audio data. The database 238 may also include files with image/object properties for image recognition and generating a base sequence in developing a replacement sequence for the video data.

While shown as residing in the memory 214, one or more of the databases 234, 236, 238 may additionally or alternatively be maintained in external repositories to which the wireless device 200 may connect.

The general purpose processor 206 and memory 214 may each be coupled to the least one baseband-RF resource chain 218, which may include at least one baseband-modem processor and at least one radio frequency (RF) resource, and which is associated with at least one SIM 204. In some embodiments, the baseband-RF resource chain 218 may be configured to receive the original media content, such as from a media source. Additionally, in some embodiments the baseband-RF resource chain 218 may be configured to receive replacement candidate samples from third party sources, which may or may not involve the same network links for receiving the original media content. In some embodiments, the original content may additionally or alternatively retrieved from a local storage medium other source of content.

The baseband-RF resource chain 218 may be coupled to at least one data buffer, such as an audio/visual (A/V) media buffer 216, which may buffer the received media content when necessary or desirable. In various embodiments, the time-shifting of tokens in the media content segments may increase flexibility of the end point device with respect to offsets between the original media content and replacement content. For example, where a duration of a substitute subject matter or synthesized base sequence does not match a duration of the replacement subject matter (i.e., content being replaced), creating the replacement sequence may involve stretching or shrinking the substitute subject matter or synthesized base sequence to generate a replacement sequence through use of the media buffer 216.

The time-shifting of tokens in the media content segments by the buffer 216 may also increase flexibility of the end point device with respect to offsets between audio and video streams when only one is subject to pre-rendering processing, or when both are subject to pre-rendering processing but unevenly (i.e., greater amount of replacement subject matter for either audio or video data compared to the other). That is, use of the media buffer 216 may avoid the need for the media source to stream the audio and video data at a time offset. In various embodiments, the media buffer 206 may be a moving window buffer that functions as a queue providing the processor enough time to analyze the media content to detect subject matter matching replacement criteria, selecting a suitable replacement when necessary, and integrating the replacement media with the media content stream before rendering. New media content segments may be received at one end of the queue, while previously received content segments from the other end of the queue are rendered or output for later rendering.

In an example embodiment, the general purpose processor 206, STT/TTS conversion engine 224, image/object description engine 225, memory 214, baseband-RF resource chain 216, and audio/video data buffer 218 may be included in a system-on-chip device 222. The at least one SIM 202 and corresponding interface(s) 204 may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some embodiments, the keypad 224, touchscreen display 226, microphone 212, or a combination thereof, may receive user inputs as part of a request to receive a media content presentation, which may be forwarded to a media source. In some embodiments, the user input may be a selection of content preferences, personalization criteria, or other information in building a user profile. Interfaces may be provided between the various software modules and functions in the wireless device 200 to enable communication between them.

The systems, methods, and devices of the various embodiments enable adaptive media content to be provided on a wireless device to one or more users. In the various embodiments, multiple wireless communication devices may receive the same original media content, which may be individually processed by each wireless communication device such that each device presents at least one media presentation with customized appropriateness or desirability.

In this manner, control over how media content is altered to fit appropriateness or desirability for a particular user is maintained at the wireless device. Since each wireless device need only appeal to a set of user profiles, the range of options for altering content may be expanded. For example, in contrast to existing systems that may filter out inappropriate words by muting the original audio or overlaying a generic noise (“bleeping”), a wireless device-based system in the various embodiments may replace the inappropriate words by inserting substitutions according to a pre-programmed language, vocabulary, and voice settings, all of which may be selected by a user or parent for a user profile.

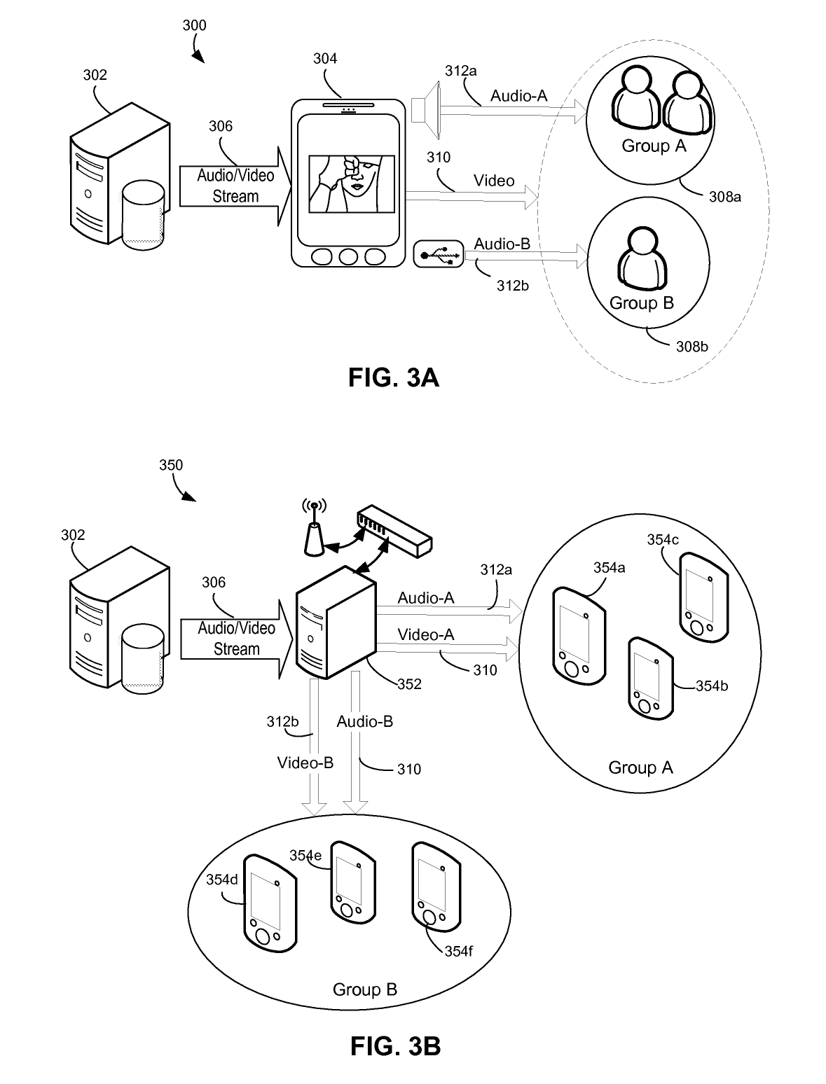

In the various embodiments, the wireless device may be any end point device capable of decoding received media content, and separately evaluating audio and/or video data of the media content on an element-by-element basis. The end point device may perform pre-rendering processing by determining, based on user profile settings and criteria, whether substitute subject matter is more appropriate than original audio and/or video elements. If more appropriate, the original audio and/or video stream may be modified by generating replacement sequences for output as part of a personalized media content presentation. This technique may be implemented by a variety of different system configurations and options, examples of which are illustrated in FIGS. 3A and 3B.

In a first configuration 300 shown in FIG. 3A, one or more content providers or other media sources, collectively represented as a media server 302, may transmit digital media content to end point devices, such as wireless devices 304 (e.g., 102, 200 in FIGS. 1-2). The media content, which is illustrated as an audio/video stream 306 in FIG. 3A, may be propagated as a data stream that is compliant with at least one data compression scheme. An example of a data compression scheme is the MPEG standard, but the claims are not limited to media of such formats.

In some embodiments, the wireless device 304 may simultaneously provide presentations to different users or groups of users through various device interfaces. For example, the wireless device 304 may contain a plurality of audio output interfaces, and may therefore provide media content presentations containing user-specific or user group-specific modifications to the audio stream. Specifically, when the wireless device 304 is being used by both a first and second user or group of users to view a media content presentation (e.g., a particular movie), the wireless device 304 may render a single video stream for all users, while rendering different audio streams for each user or group that is customized according to user profile information. For example, as shown in configuration 300, an individual first user 308a and a group of second users 308b may view a video stream 310, which may be the original video data from the audio/visual stream 306). However, the wireless device 304 may separately render a first audio stream (“Audio-A”) 312a for the first user 308a, and a second audio stream (“Audio-B”) 312b for the group of second users 308b.

To provide the personalized media presentations to the different users, the wireless device 304 may synchronize each of Audio-A 312a and Audio-B 312b with the original video stream. Synchronization may be achieved, for example, by buffering the original video data during pre-rendering processing of the audio data. Alternatively, synchronization may be achieved by receiving delayed original video stream from the media server 302, and correcting for the time offset (i.e., time period between receiving audio data and the corresponding original video data). Following synchronization, the wireless device 304 may render Audio-A 312a by outputting modified audio data through a speaker (e.g., 210) of the wireless device 304, and may render Audio-B 312b by outputting different modified audio data through one or more peripheral devices. The peripheral devices used to output modified audio data to a particular user or group (e.g., Audio-B 312b to the user group 308b) may include for example, earbuds, headphones, a headset, an external speaker, etc. In some embodiments, the one or more peripheral devices may be connected to the wireless device 304 via a wired connection (e.g., through a 6.35 mm or 3.5 mm telephone jack, USB port, microUSB port, etc.) or wireless connection (e.g., through Bluetooth signaling or other near field communication (NFC)). In various embodiments, the presentation of customized media content by configuration 300 may be extended to more than two users/user groups by adding an additional peripheral device for each different audio stream to be rendered.

Additional embodiment configurations may be implemented if the wireless device is capable of displaying multiple video streams simultaneously. For example, the wireless device may be configured with a lenticular screen to enable such configurations. At a first viewing angle, a user can see a first video displayed on the screen, or a portion of the screen, but is prevented from seeing a second video displayed, while at a second viewing angle a user sees the second video displayed on the screen, or a different portion of the screen, but is prevented from seeing the first video. Therefore, in some embodiments, different users may each view a video stream that is edited/customized according to the user profile, instead of or in addition to receiving the customized audio streams. In some embodiments, application of such multiple video display capability may be useful in advertising. For example, an image of a generic tablet in the received original video data may be replaced with an image of an iPad in the video viewable to a first user or group of users, and replaced with an image of a Microsoft SurfacePro in the video viewable to a second user or group of users. In this manner, revenue agreements or other negotiating opportunities may be enabled with multiple advertisers for the same video data.

In some embodiments, instead of performing both pre-rendering processing of original media content and rendering the modified media content on a single end point device, processing may be performed by an intermediate device. In particular, one or multiple end point devices may be in communication with an intermediate device, which in turn receives media content from media, sources (e.g., content providers). For example, the intermediate device may be an applications server running a media management application that is capable of distributing medias content to multiple end point devices.

Similar to the wireless devices discussed above with respect to FIG. 3A, an intermediate device may perform separate pre-rendering processing on the audio data and/or the video data of the received media content. One or more user profiles that is defined using various personalization criteria (e.g., gender, age, geographic, location, etc.) may be stored on or accessible to the intermediate device. Upon receiving media content, in some embodiments the intermediate device may apply the one or more user profiles to the audio and/or video data. In some embodiments, such application may be based on the identity of wireless devices in one or more identifiable “audiences.” In some embodiments audience end point devices may be identified based on information received during exchanges between wireless devices and the media server to establish a communication link (i.e., handshaking). Such signaling may be initiated, for example, based on proximity broadcast detection by audience end point devices, as discussed in further detail below. Further, information transmitted to the media server over the established communication links may be passed to the intermediate device. Such information may be used by the intermediate device to characterize identified end point audience devices based on criteria that define the one or more profiles (e.g., approximate age, gender, favorite music or movie genres, etc. of the current user for an end point device). Additionally or alternatively, the intermediate device may be configured with a crowd-facing camera, enabling the intermediate device to identify position and profile criteria parameters for current users of the connected audience end point devices.

In some embodiments, audience end point devices may be identified based on their proximity to a particular location, such as the location of the intermediate device itself, the location of the media server, and/or a location that is remote from the intermediate device and media server. In some embodiments, the wireless communication device may receive signals broadcast by a wireless identity transmitter (i.e., a “proximity beacon”) associated with the particular location. The proximity beacon may be configured to broadcast identification messages via a short-range wireless radio, such as a Bluetooth Low Energy (LE) transceiver, which may be received by physically proximate end user devices that are configured with corresponding receivers and proximity detection application. Broadcast messages from proximity beacons may be received by user end point devices within a particular reception range, for example, within 0-25 feet. In some embodiments, user end point devices may relay received broadcast signals, along with other information (e.g., timestamp data, identifier, proximity information, etc.), to the intermediate device or media source in the form of sighting messages. In this manner, the intermediate device may identify audience end point devices and their positions for one or more associated proximity beacons. In some embodiments, pre-rendering processing functionality may be automatically triggered on the intermediate device for current media content upon receiving sighting messages from one or more audience end point devices. In other embodiments, such functionality may be triggered in response to receiving, at the intermediate device, a request for media content presentation from one or more user end point devices. In some embodiments, after the pre-rendering of audio and/or visual data personalized media presentations may be passed automatically to corresponding relevant audience devices.

FIG. 3B shows an example system configuration 350 that uses an intermediate device to provide media content presentations containing user- or group-specific modifications to the audio stream. In some embodiments, the media server 302 may send the original audio/visual stream 306 to an intermediate device 352, which may be coupled or connected to a communication network. Using a network connection, the intermediate device 352 may identify connected audience end point devices, capabilities, and information about current users through on one or more of the techniques discussed above. In an example application the media server 302 may be located at or associated with a tourist location, such as a museum. The intermediate device 352 and/or media server 302 may identify endpoint devices 354a-354f as being wireless communication devices that are located inside the museum (or in proximity to a particular exhibit of the museum), and that are each capable of outputting one audio stream and one video stream simultaneously.

In this example, the intermediate device 352 may also determine that the users of endpoint devices 354a-354c are tourists from the United Kingdom, and that the users of endpoint devices 354d-354e are students from Japan.

Based on the determinations, as well as information received from the media server 302, the intermediate device 352 may determine the type of pre-rendering processing to perform on received media content, and may select one or more applicable user profiles. In this embodiment, the intermediate device 352 may determine that the audio stream of the received media content can be modified for different groups, but that the video stream is not modifiable (e.g., based on restrictions from the media source, etc.). The intermediate device 352 may apply a first user profile to the audio data to create the modified audio stream (i.e., Audio-A 312a) for endpoint devices 354a-354c (“Group A”). In this example, applying the first user profile may replace American English words or phrases in the original audio stream with their equivalents in British English. For example, the word “elevator” may be replaced with the term “lift,” “truck” with “lorry,” “tuxedo” with “dinner jacket,” etc.

The intermediate device 352 may apply a second user profile to the audio data to create the second modified audio stream (i.e., Audio-B 312b) for endpoint devices 354d-354f (“Group B”). In this example, applying the second user profile may replace certain English phrases that may not be easily understood by a visiting non-native English speaker (e.g., acronyms, figures of speech, idiomatic expressions, etc.) with more direct terms that have the same or similar meanings. For example, the expression “teacher's pet” may be replaced with “teacher's favorite student,” the term “Capitol Hill” replaced with “United States Congress,” etc. Additionally or alternatively, the second user profile may replace certain English words or phrases with others that correspond to a particular vocabulary lesson, or that vary in complexity based on the level of instruction achieved by the students in Group B.

In applying both the first and second user profiles, amounts of currency, quantities, etc. may be converted into appropriate units. For example, measurements in U.S. customary units (e.g., inches, quarts, miles, etc.) may be converted to metric system units in the modified audio streams for both Groups A and B, while U.S. dollar amounts may be converted into pounds in the for Group A and into yen for Group B. Following pre-rendering processing for Groups A and B, the intermediate device 352, may synchronize the original video stream 310 with each audio stream Audio-A 312a and Audio-B 312b. As discussed above with respect to FIG. 3A, may be achieved by buffering the original video data during pre-rendering processing, or by receiving a delayed original video stream and correcting for the time offset. The intermediate device 3522 may transmit personalized media content presentations to the end point devices in Group A (e.g., 354a-354c) and in Group B (e.g., 354d-354f) for rendering. Specifically, the personalized media content presentation sent to Group A may be the modified audio stream from applying from the first user profile, and the original video stream, while the presentation sent to Group B may be the modified audio stream from applying the second user profile and the original video stream.

Another embodiment of the system configuration 350 may involve modifying the video stream for different endpoint devices (not shown), instead of or in addition to a modifying the audio stream. For example, the intermediate device 352 may determine that one or more endpoint device belongs to a New England Patriots fan, or group of Patriots fans, and may reflect such preference by applying a user profile to sports-related content. In an example, an advertisement that features a clip of another NFL quarterback (e.g., Peyton Manning) in a video stream during a sports game or highlights show may be modified by substituting a video clip of Tom Brady or superimposing Tom Brady's face on Peyton Manning's body. The intermediate device 352 may provide the modified video stream to the endpoint device(s) belonging to the identified Patriots fans, while other users or groups of users may receive the original video stream.

In various embodiments, the intermediate device may be configured with an intelligent network interface/media manager, such as provided by Qualcomm® StreamBoost™ technology. In various embodiments, StreamBoost™ may be used to automatically identify and classify various types of data on a network (e.g., a LAN), including content from one or more media sources. In this manner, the endpoint device(s) of a user or a group of users accessing each type of media content (e.g., streaming real-time or recorded video or podcast, music files, etc.) may be allocated a certain amount of bandwidth based on need (e.g., using traffic shaping). Further, StreamBoost™ may provide a cloud-based service that allows the intermediate device to dynamically identify endpoint devices of users as they connect to the network. In some embodiments, the content being accessed by each user or group of users may be utilized by the intermediate device to apply and/or develop a user profile.

While system configuration 350 includes wireless endpoint devices that each operate to output a modified media content presentation to one or more users, such endpoint devices are provided merely as an example, as configuration 350 may additionally or alternatively include various end point devices that are only capable of audio rendering (e.g., speaker, headphones, etc.) or video rendering. That is, in various embodiments, a modified media content presentation to a user or group of users may involve outputting an audio stream from one device and displaying the video stream on another device.

The references to first and second users, audio and/or video streams, user profiles, and presentations are arbitrary and used merely for the purposes of describing the embodiments. That is, the processor of an end point device or intermediate device may assign any indicator, name, or other designation to differentiate data and processing associated with different groups, without changing the embodiment methods. Further, such designations of the users, audio and/or video streams, user profiles, and presentations may be switched or reversed between instances of executing the methods herein

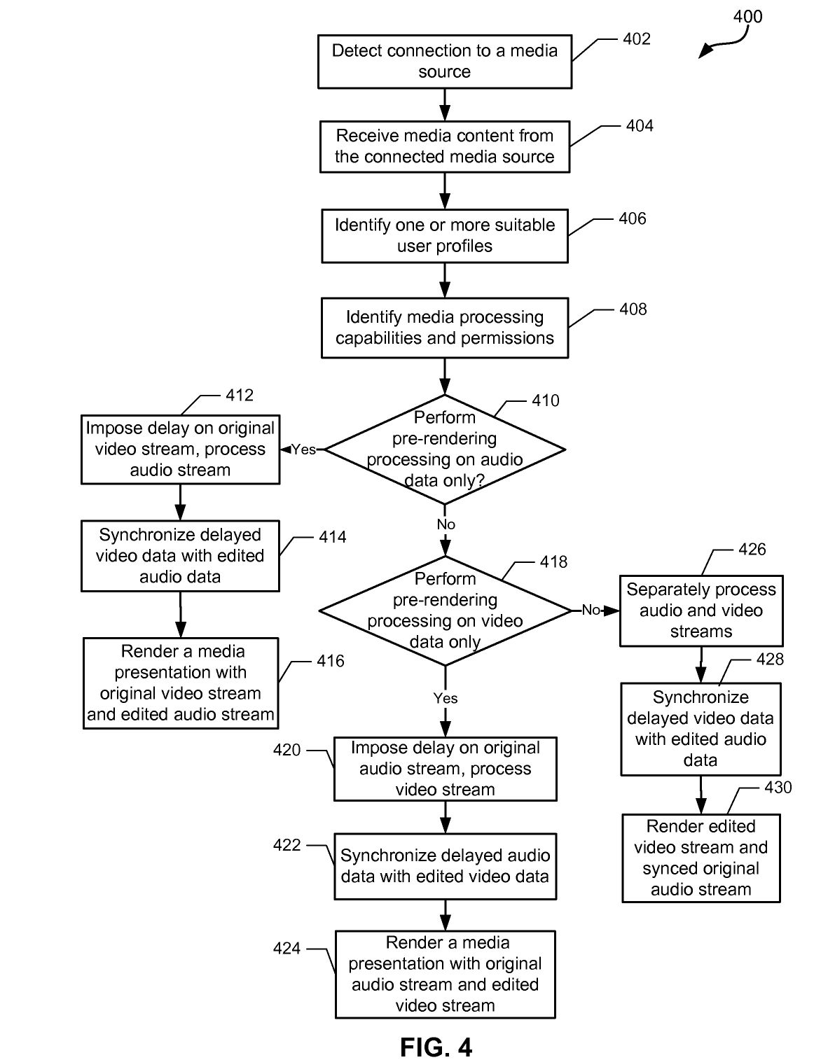

FIG. 4 illustrates a method 400 of generating a personalized media content presentation on an end point device according to some embodiments. With reference to FIGS. 1-4, the operations of the method 400 may be implemented by one or more processors of the wireless device 200, such as the general purpose processor(s) 206, or a separate controller (not shown) that may be coupled to the memory 214 and to the general purpose processor(s) 206.

While the descriptions of the various embodiments address creating one personalized presentation of media content source by one end point device, the various embodiment processes may be implemented by multiple end point devices, and may be used to create multiple media content presentations. Further, while the descriptions of the various embodiments address audio and/or visual data that is received by and processed on the end point device, the various embodiment processes may be implemented by using an intermediate device to perform some or all of the media processing, as discussed above with reference to FIG. 3B.

While the creation of personalized media content presentations depends on the particular capabilities associated with the end point device(s) and rules configured to be implemented by modules of the processor(s), a general algorithm for local customization of audio and/or video data may proceed according to method 400.

In block 402, the wireless device processor may detect a connection to a media source (e.g., a content provider), such as through a wireless or wired communication network In block 404, the wireless device processor may receive media content from the connected source, for example via broadcast, multicast, or unicast transmission. In block 406, the wireless device processor may identify one or more suitable user profiles that may be applied to the received media content. When a customized media presentation is being rendered for one user or group of users, only one suitable user profile may be identified. However, when a customized media presentation is being rendered for each of multiple users or groups of users, a plurality of different suitable user profiles may be identified.

In some embodiments, such identification of one or more suitable user profiles may be based on data received from one or more sensors coupled to or implemented in the wireless device (e.g., crowd-facing camera, microphone, sound level meter, etc.). For example, the wireless device may be capable of receiving images of users in an audience and using a facial recognition system to identify the users. In another example, the wireless device may be capable of recording audio data from an audience, and using a speech recognition system to identify the users. Further, based on the recorded audio data, the wireless device may measure an ambient noise level from the recorded audio data in order to estimate a number of audience members, as well as age and gender.

In some embodiments, based on the detected information about the users or a number of users, the wireless device processor may retrieve corresponding user profile information stored in memory. In other embodiments, the detected information about users may be used in conjunction with historical information to dynamically modify or develop a suitable user profile. For example, the wireless device may identify the users in the audience through facial or voice recognition, and may retrieve past usage data indicating (e.g., through facial expression recognition or other behavioral/biometric detection) that these users previously reacted negatively when viewing violent scenes in movies. As a result, a retrieved suitable user profile identified by the wireless device may be updated to include violence in video scenes as part of the replacement subject matter. In some embodiments, one or more suitable user profiles may be identified by receiving manual input from a user (i.e., express selection of one or more user profiles).

In block 408, the wireless device processor may identify media processing capabilities and permissions associated with the wireless device processor and media source. Such identification may include detecting the local processing capabilities for modifying audio and visual data. For example, the wireless device processor may lack logic or hardware for a required conversion engine or other function. The identification in block 408 may also include detecting the modifiable properties of the audio and visual data, including permissions and/or restrictions. For example, the media source may provide certain media content in which one or both of the audio and visual data may be subject to limited or no modification.

In determination block 410, the wireless device processor may determine, based on the capabilities and permissions identified in block 408, whether to only perform pre-rendering processing on the audio data of the received media content.

In response to determining that the processor should only perform pre-rendering processing on the audio data (i.e., determination block 410=“Yes”), the wireless device processor may impose a delay on the original video stream and process the audio stream in block 412. In block 414, the wireless device processor may synchronize the delayed video data with edited audio data. In block 416, the wireless device processor may render a media presentation that includes the original video stream and the edited audio stream. In some embodiments, such as for pre-recorded media content, delaying of the original video and processing of the audio stream, synchronizing, and rendering of the original video stream and edited audio stream may be performed on the entire media content. That is, the wireless device processor may delay the entire video stream until completion of processing of the entire audio stream, after which the streams may be synchronized and rendered. In other embodiments, such as for media content that is streaming live from the media source, delaying of the original video stream and processing of the audio stream, synchronizing, and rendering of the original video stream and edited audio stream may be performed on a per segment basis (e.g., using a buffer) such that the wireless device processor may dynamically render each segment as soon as possible.

In response to determining that the processor should process more than the audio data (i.e., determination block 410=“No”), the wireless device processor may determine, based on the capabilities and permissions identified in block 408, whether to only perform pre-rendering processing on the video data of the received audio content in determination block 418. In response to determining that the processor should only perform pre-rendering processing on the video data (i.e., determination block 418=“Yes”), the wireless device processor may impose a delay on the original audio stream and process the video stream in block 420. In block 422, the wireless device processor may synchronize the delayed audio data with edited video data. In block 424, the wireless device processor may render a media presentation that includes the original audio stream and the edited video stream. As discussed above, the delay and processing, synchronization, and rendering may be performed either as to the entire media content or on a per segment basis.

In response to determining that the processor should perform pre-rendering processing on more than just the video data (i.e., determination block 418=“No”), the wireless device processor may separately process the audio and video data in block 426. In block 428, the wireless device processor may synchronize the edited audio data with the edited video data. In block 430, the wireless device processor may render a media presentation that includes the edited audio stream and the edited video stream. As discussed above, the delay and processing, synchronization, and rendering may be performed either as to the entire media content or on a per segment basis.

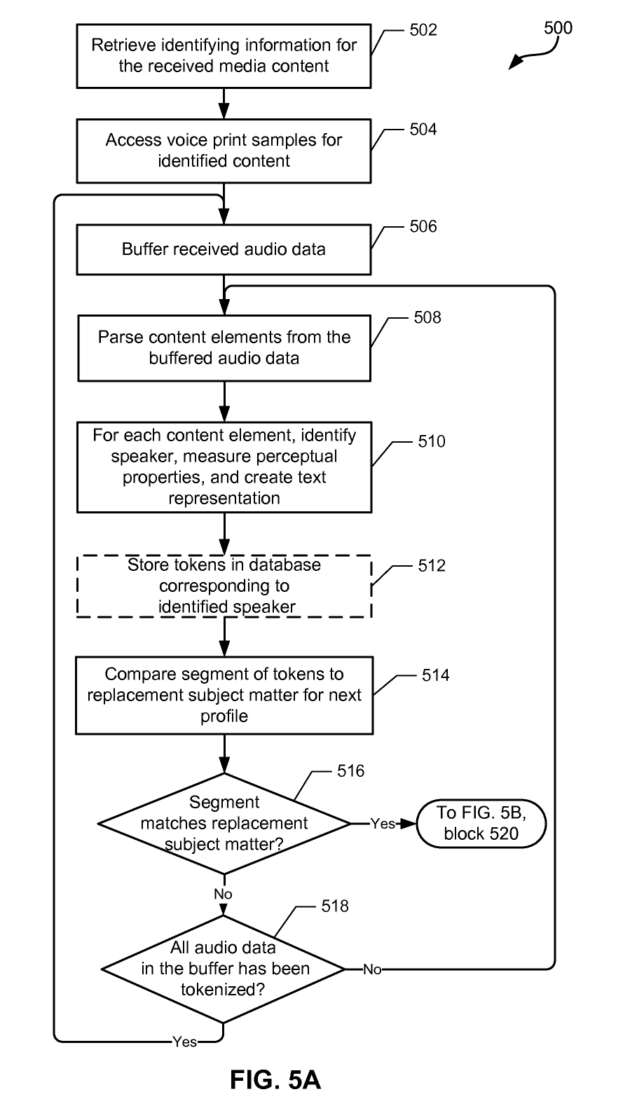

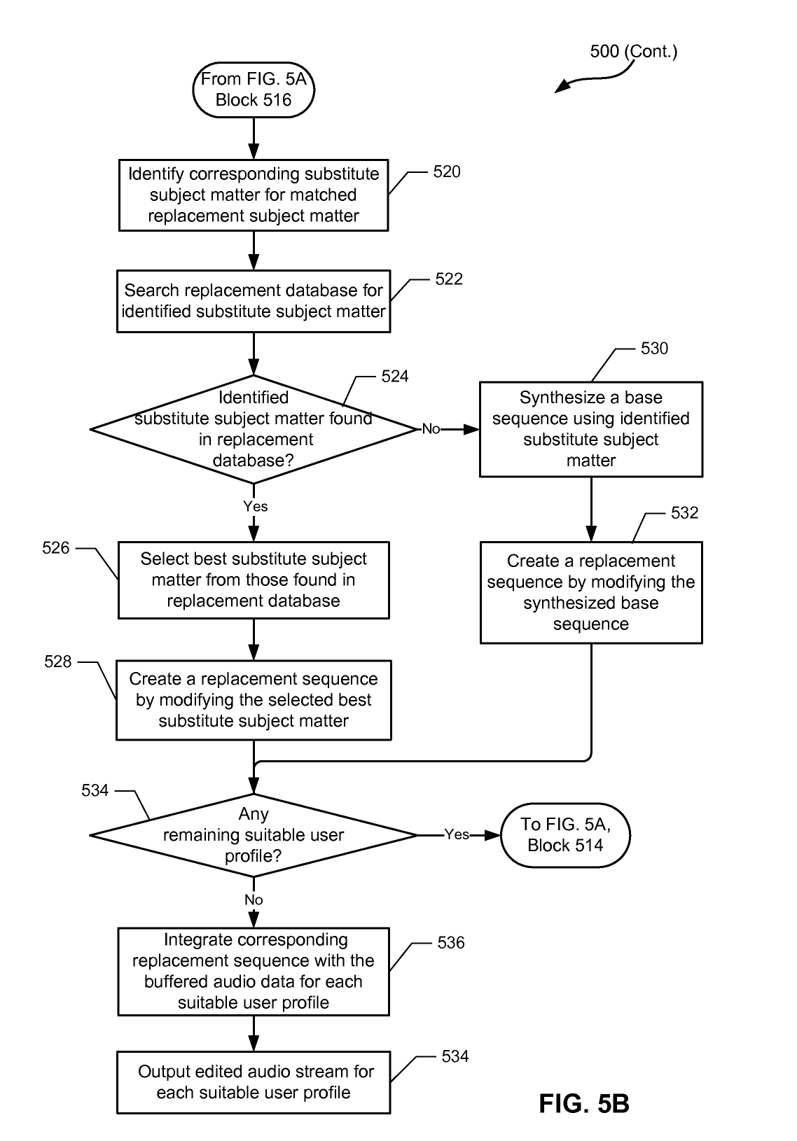

FIGS. 5A and 5B together illustrate a method 500 of performing the pre-rendering processing of the audio data in block 412 and/or block 426 of FIG. 4. With reference to FIGS. 1-5B, the operations of the method 500 may be implemented by one or more processors of the wireless device 200, such as the general purpose processor(s) 206, or a separate controller (not shown) that may be coupled to the memory 214 and to the general purpose processor(s) 206.

In block 502 (FIG. 5A), the wireless device processor may retrieve identifying information for the received media content. In some embodiments, the identifying information may include at least one title associated with a presentation provided by the media content (e.g., movie title, television show and/or episode title, song name, podcast series title, etc.). For example, the title may be retrieved from metadata received with the audio stream from the media source. In some embodiments, the identifying information may include at least one speaker contributing to the audio stream of the media content. While referred to as a speaker, in some types of media content (e.g., song tracks) the term “speaker” may refer interchangeably to a person who has provided spoken words and audible singing for a media content presentation. For example, the speaker names may also be retrieved from metadata received with the audio stream from the media source. In another example, the wireless device processor may access at least one third party database to determine speaker identities, such as by inputting the retrieved title information into a search engine (e.g., IMDB). The search engine may find the names of speakers associated with that title, and provide the names to the wireless device processor.

In block 504, the wireless device processor may access voice print samples for the identified content. In some embodiments, the wireless device processor may obtain such samples from existing tokens corresponding to the identified speakers. For example, the wireless device processor may retrieve, from a replacement database (e.g., 236), tokens that have been dynamically created during the pre-rendering processing of that media content. In some embodiments, the wireless device processor may obtain voice print samples by accessing a third party database, and downloading portions of other media content available for each of the identified speakers.

In block 506, the wireless device processor may buffer the received audio stream, for example, using a moving window buffer (e.g., A/V media buffer 216). In some embodiments, the buffering of the received audio data may provide a time delay between receiving the original media content and creating modified audio data, allowing the wireless device processor to perform dynamic processing and rendering on a per segment basis.

In the various embodiments, the wireless device processor may create tokens from the audio data of the received media content. Specifically, in block 508, the wireless device processor may parse individual content elements from the buffered audio data. Such content elements may be, for example, phonemes, words, phrases, sentences, or other unit of speech. In block 510, the wireless device processor may identify a speaker, measure perceptual properties, and create a text representation of each parsed content element. In some embodiments, identifying the speaker may be performed through applying a voice recognition system using the voice print samples from block 504. That is, a number of features may be extracted from the parsed content elements, which are compared to features extracted from the voice print samples in order to identify a match. In some embodiments, the perceptual properties measured for each content element may be pitch, timbre (i.e., tone quality), loudness, and/or any other psychoacoustical sound attributes. That is, the perceptual properties may be measure of how the audio content elements are perceived by the human auditory system instead of the physical properties of their signals.

In optional block 512, some or all of the created tokens (i.e., parsed content elements and corresponding speaker, perceptual properties, and text representation) may be stored in a database by the wireless device processor. For example, the wireless device processor may store each token in a replacement database (e.g., 236), which may organize the tokens according to the identified speaker for later retrieval/use. In some embodiments, the wireless device processor may automatically store each token in the replacement database upon creation. In some embodiments, the wireless device processor may be configured to store tokens that match one or more substitute subject matter items listed in an identified suitable user profile identified in block 406 (FIG. 4).

In block 514, the wireless device processor may compare a segment of tokens within the buffered audio data to replacement subject matter associated with a next identified suitable user profile from block 406 (FIG. 4). In determination block 516, the wireless device processor may determine whether the segment of tokens matches replacement subject matter listed in the user profile. In some embodiments, the replacement subject matter may provide particular words, phrases, speakers, etc. that should be replaced in customizing the audio data for the corresponding users. In some embodiments, the identification of replacement subject matter may be of a particular event. For example, the audio data may be analyzed and tokens classified as matching audio properties of an explosion, a high-speed chase, a party, etc. In some embodiments, the identification of replacement subject matter may be of music played by a particular band or recording artist, such as in a movie or television show. n response to determining that the segment of tokens does not match replacement subject matter listed in the user profile (i.e., determination block 516=“No”), the wireless device processor may determine whether all of the audio data in the buffer has been tokenized in determination block 518. In response to determining that not all of the audio data in the buffer has been tokenized (i.e. determination block 518=“No”), the wireless device processor may return to parse the content elements from the buffered audio data in block 508. In response to determining that all of the audio data in the buffer has been tokenized (i.e., determination block 518=“Yes”), the wireless device processor may return to continue to buffer the received audio data in block 506.

In response to determining that the segment of tokens matches replacement subject matter listed in the user profile (i.e., determination block 516=“Yes”), the wireless device processor may identify corresponding substitute subject matter for the matched replacement subject matter in block 520. Such identification may be performed, for example, by accessing the user profile, which may list at least one substitute subject matter corresponding to each listed replacement subject matter.

In block 522, the wireless device processor may search a replacement database for the at least one identified substitute subject matter corresponding to the matched replacement subject matter. In some embodiments, the replacement database may store tokens as entries associated with the various speakers/actors. Therefore, such searching the replacement database may involve searching for one or multiple tokens that match the identified speaker(s) for the tokens in the segment, and having text representations matching any of the substitute subject matter.

In determination block 524, the wireless device processor may determine whether any of the identified substitute subject matter is found in the replacement database. In response to determining that one or more identified subject matter items are found in the replacement database (i.e., determination block 524=“Yes”), the wireless device processor may select the best substitute subject matter of those found in block 526. When only one substitute subject matter item is found, that one time may be automatically selected as the best. When more than one identified subject matter is found, the best substitute subject matter item may be selected, such as based on the degree of similarity between the perceptual properties stored for the substitute subject matter and those measured for the tokens within the segment. In another example, the best substitute subject matter may be selected based on rankings or preferences that are specified by the user or group of users, which may be included in the user profile.

In block 528, the wireless device processor may create a replacement sequence by modifying characteristics of the selected best substitute subject matter. In some embodiments, the modification may involve manipulating the content elements of the selected best substitute subject matter to match or closely track the measured perceptual properties of the tokens within the segment.

In response to determining that none of the identified substitute subject matter is found in the replacement database (i.e., determination block 524=“No”), the wireless device processor may synthesize a base sequence using the identified substitute subject matter in block 530. For example, when the identified substitute subject matter is one or more age-appropriate replacements for a particular swear word, the wireless device processor may employ a voice synthesizer to create a computer generated voice speaking an identified substitute subject matter. In another example, when the identified substitute subject matter involves using a different speaker saying the original words or lyrics, the wireless device processor may employ a voice synthesizer to create a computer generated voice speaking the text representation of the tokens in the segment.

In block 532, the wireless device processor may create a replacement sequence by modifying the characteristics of the synthesized base sequence. For example, the wireless device processor may manipulate the base sequence to match or closely track the measured perceptual properties of the tokens within the segment.

In determination block 534, the wireless device processor may determine whether there is any remaining suitable user profile of those identified in block 406 (FIG. 4). In response to determining that there is one or more remaining suitable user profiles (i.e., determination block 534=“Yes”), the wireless device processor may again compare the segment of tokens within the buffered audio data to replacement subject matter associated with the next identified suitable user profile in block 514 (FIG. 5A).

In response to determining that there is no remaining suitable user profile (i.e., determination block 534=“No”), the wireless device processor may integrate the corresponding replacement sequence with the buffered audio data for each of the suitable user profiles in block 536. In block 538, the wireless device processor may output an edited audio stream for each of the suitable user profiles.

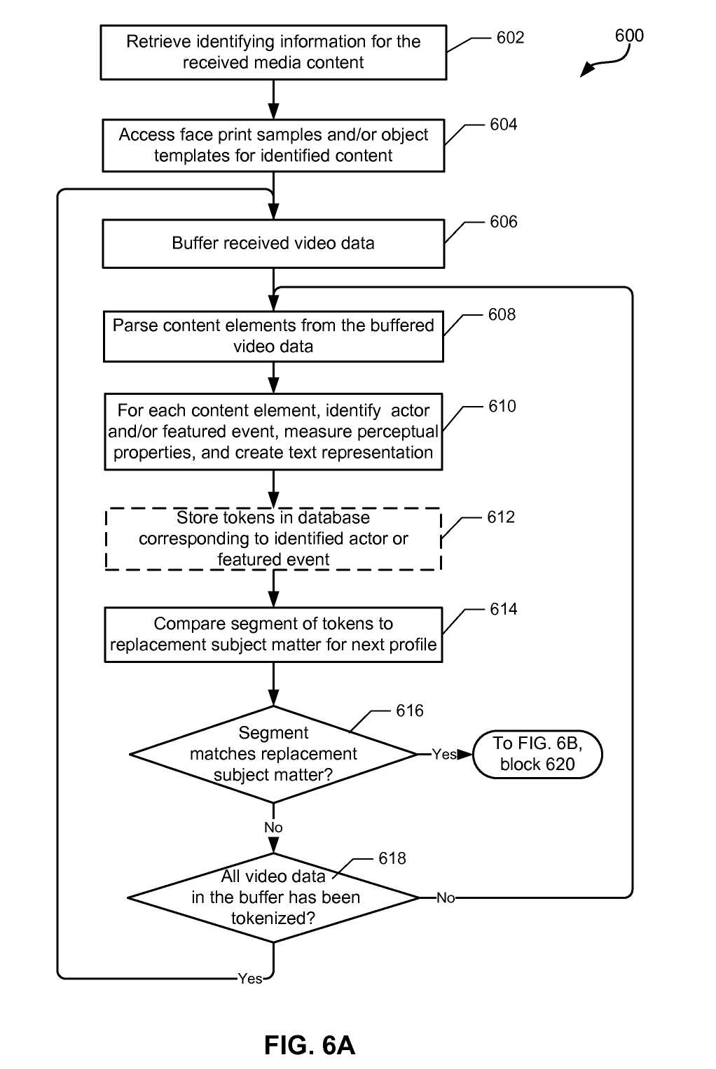

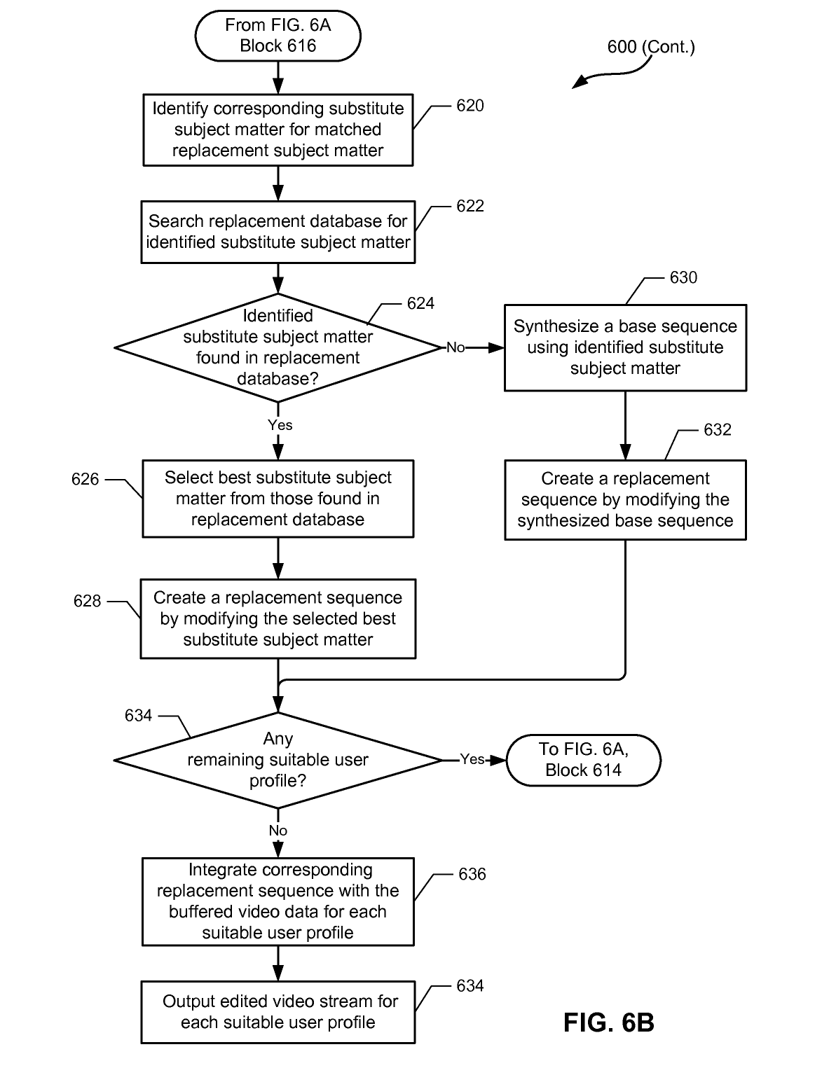

FIGS. 6A and 6B together illustrate a method 600 of performing the pre-rendering processing of the video data in block 420 and/or block 426 of FIG. 4. The operations of the method 600 may be implemented in one or more processors of the wireless device 200, such as the general purpose processor(s) 206, or a separate controller (not shown) that may be coupled to the memory 214 and to the general purpose processor(s) 206.

In block 602 (FIG. 6A), the wireless device processor may retrieve identifying information for the received media content, which may include at least one title associated with a media presentation. For example, the title may be retrieved from metadata received with the video stream from the media source. In some embodiments, the identifying information may include at least one actor in the video being shown. While referred to as an actor, in some types of media content (e.g., still shot images, etc.) the term “actor” may refer interchangeably to a person who appears in filmed content and a person whose image or likeness is being shown in a media content presentation. In some media content presentations, the identifying information may include at least one of location, subject matter, or item (i.e., featured events) associated with the video, in addition or as an alternative to the at least one actor.

In some embodiments, the wireless device processor may access at least one third party database to determine the identities of actors or featured events of the video, such as by inputting the retrieved title information into a search engine (e.g., IMDB). The search engine may find the names of actors and/or featured events associated with that title, and provide the names to the wireless device processor.

In block 604, the wireless device processor may access face print samples and/or object templates for the identified content. In some embodiments, the wireless device processor may obtain such samples from existing tokens corresponding to the identified actors or featured events. For example, the wireless device processor may retrieve, from a replacement database (e.g., 236), tokens that have been dynamically created during the pre-rendering processing of that media content. In some embodiments, the wireless device processor may obtain face print samples and/or object templates by accessing a third party database, and downloading portions of other media content available for each of the identified actor and/or featured event.

In block 606, the wireless device processor may buffer the received video stream, for example, using a moving window buffer (e.g., A/V media buffer 216). In some embodiments, the buffering of the received video data may provide a time delay between receiving the original media content and rendering the video (including any modified video), providing the wireless device processor with sufficient time to perform dynamic processing and rendering to modify the video on a per segment basis.

In the various embodiments, the wireless device processor may create tokens from the video data of the received media content. For example, in block 608, the wireless device processor may parse individual content elements from the buffered video data. Such content elements may be, for example, images, frames, film stills, film scenes, or other visual unit.

In block 610, the wireless device processor may identify an actor and/or featured event, measure perceptual properties, and create a text representation of each parsed content element. In some embodiments, identifying the actor and/or featured event may be performed through applying a facial or object recognition system using the face print samples or other object templates from block 604. In other words, a number of visual features may be extracted from the parsed content elements, which are compared to features extracted from the face print samples or object templates in order to identify a matching actor or featured event (e.g., location, object, etc.). Such feature extraction processes may include various levels of complexity involving, for example, identification of lines, edges, ridges, corners, etc. In some embodiments, the perceptual properties measured for each content element may include, for example, frame rate, lighting and/or texture, motion analyses, and/or any other quality that involves visual reception, as discussed above.

In optional block 612, some or all of the created tokens (i.e., parsed content elements and corresponding actor and/or featured event, perceptual properties, and text representation) may be stored in a database by the wireless device processor. For example, the wireless device processor may store each token in a replacement database (e.g., 236), which may organize the tokens according to the identified actor or featured event for later retrieval/use. In some embodiments, the wireless device processor may automatically store each token in the replacement database upon creation. In some embodiments, the wireless device processor may be configured to store tokens that match one or more substitute subject matter items listed in an identified suitable user profile identified in block 406 (FIG. 4).

In block 614, the wireless device processor may compare a segment of tokens within the buffered video data to replacement subject matter associated with a next identified suitable user profile from block 406 (FIG. 4). In determination block 616, the wireless device processor may determine whether the segment of tokens matches replacement subject matter listed in the user profile. In some embodiments, the replacement subject matter may provide particular actors, featured events, and/or combinations of other visual criteria that should be replaced in customizing the video data for the corresponding users.

In response to determining that the segment of tokens does not match replacement subject matter listed in the user profile (i.e., determination block 616=“No”), the wireless device processor may determine whether all of the video data in the buffer has been tokenized in determination block 618. In response to determining that not all of the video data in the buffer has been tokenized (i.e. determination block 618=“No”), the wireless device processor may return to parsing the content elements from the buffered video data in block 608. In response to determining that all of the video data in the buffer has been tokenized (i.e., determination block 618=“Yes”), the wireless device processor may return to continue to buffer the received video data in block 606.

In response to determining that the segment of tokens matches replacement subject matter listed in the user profile (i.e., determination block 616=“Yes”), the wireless device processor may identify corresponding substitute subject matter for the matched replacement subject matter in block 620. Such identification may be performed, for example, by accessing the user profile, which may list at least one substitute subject matter corresponding to each listed replacement subject matter.

In block 622, the wireless device processor may search a replacement database for the at least one identified substitute subject matter corresponding to the matched replacement subject matter. In some embodiments, the replacement database may store tokens as entries associated with the various actors and/or featured events. Therefore, such searching of the replacement database may involve searching for one or multiple tokens that match the identified actor(s) or featured event(s) for the tokens in the segment, and having text representations matching any of the substitute subject matter.

In determination block 624, the wireless device processor may determine whether any of the identified substitute subject matter is found in the replacement database. In response to determining that one or more identified subject matter items are found in the replacement database (i.e., determination block 624=“Yes”), the wireless device processor may select the best substitute subject matter of those found in block 626. When only one substitute subject matter item is found, that one item may be automatically selected as the best. When more than one identified subject matter item is found, the best substitute subject matter item may be selected, such as based on the degree of similarity between the perceptual properties stored for the substitute subject matter and those measured for the tokens within the segment. In another example, the best substitute subject matter may be selected based on rankings or preferences that are specified by the user or group of users, which may be included in the user profile.

In block 628, the wireless device processor may create a replacement sequence by modifying characteristics of the selected best substitute subject matter. In some embodiments, the modification may involve manipulating the content elements of the selected best substitute subject matter to match or closely track the measured perceptual properties of the tokens within the segment.

In response to determining that none of the identified substitute subject matter is found in the replacement database (i.e., determination block 624=“No”), the wireless device processor may synthesize a base sequence using the identified substitute subject matter in block 630. For example, when the identified substitute subject matter is one or more age-appropriate replacements for a particular movie scene, the wireless device processor may create sets of three-dimensional images that may be stretched together into point clouds and three-dimensional models. In some embodiments, such creation may involve using various imaging tools and the image/object description engine 226 (FIG. 2).

In block 632, the wireless device processor may create a replacement sequence by modifying the characteristics of the synthesized base sequence to be consistent with the measured perceptual properties of the tokens within the segment. For example, the wireless device processor may manipulate the base sequence to match or closely track the measured perceptual properties of the tokens within the segment.

In determination block 634, the wireless device processor may determine whether there is any remaining suitable user profile of those identified in block 406 (FIG. 4). In response to determining that there is one or more remaining suitable user profiles (i.e., determination block 636=“Yes”), the wireless device processor may again compare the segment of tokens within the buffered video data to replacement subject matter associated with the next identified suitable user profile in block 614 (FIG. 6A).

In response to determining that there is no remaining suitable user profile (i.e., determination block 634=“No”), the wireless device processor may integrate the corresponding replacement sequence with the buffered video data for each of the suitable user profiles in block 636. In block 638, the wireless device processor may output an edited video stream for each of the suitable user profiles.

The accuracy of the replacement sequences created in the various embodiments may directly correspond to the amount of delay incurred in the output edited audio and/or video stream. In some embodiments, the level of refinement to be used in the pre-rendering processing may be adjustable such that the system or user may select a presentation having short delay (with less accurate replacement sequences) or having a high level of accuracy (with longer delay).

In the various embodiments, the creation and integration of replacement sequences with the buffered audio and/or video data (e.g., blocks 528, 536 in FIG. 5B and blocks 628, 636 in FIG. 6B) may involve using various media processing techniques to achieve output streams that sound and/or look seamless in the rendered media presentation. For example, with respect to replacement subject matter that is based on speech (i.e., a particular speaker, word(s), etc.), creating a replacement sequence may involve filtering speech data from the original audio stream, and separating the speech data from the background audio data. Further, integrating the created replacement sequence may involve “blending” with the background audio from the original audio stream.

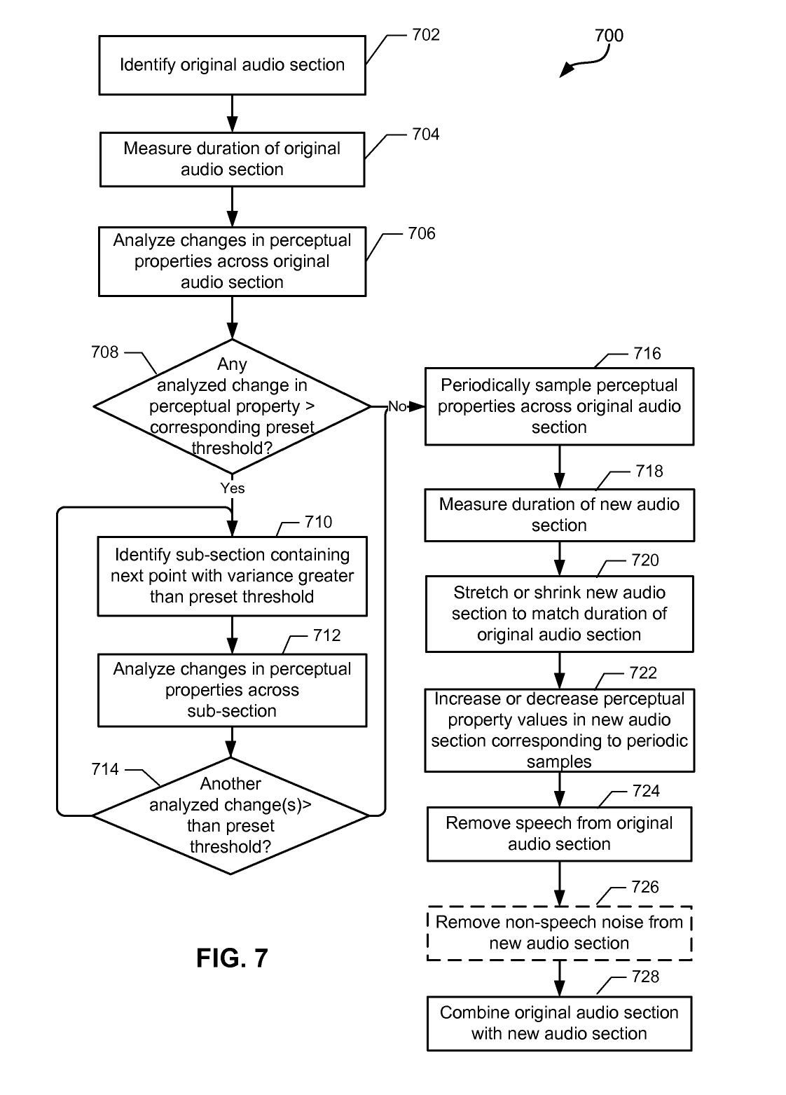

FIG. 7 illustrates a method 700 for creating and/or integrating a replacement sequence during the pre-rendering processing of audio data. With reference to FIGS. 1-7, the operations of the method 700 may be implemented by one or more processors of the wireless device 200, such as the general purpose processor(s) 206, or a separate controller (not shown) that may be coupled to the memory 214 and to the general purpose processor(s) 206. Further, method 700 may make up some or all of the operations in block 528 and/or block 536 of FIG. 5B. Moreover, while provided with respect to a word(s) identified as replacement subject matter in a user profile, the operations in method 700 may be applied to any speech or other audio data that has characteristics matching replacement subject matter.

In block 702, the wireless device processor may identify a section in the original audio data that will be replaced by replacement sequence (“original audio section”). In block 704, the wireless device processor may measure the duration of the original audio section. In block 706, the wireless device processor may analyze changes in perceptual properties across the original audio section. Such perceptual properties may include, but are not limited to, pitch, volume, and tempo. In determination block 708, the wireless device processor may determine whether any analyzed change in a perceptual property is greater than a preset threshold variance corresponding to that property. That is, the wireless device processor may determine whether any change in pitch is greater than a threshold variance for pitch, any change in volume is greater than a threshold variance for volume, etc. In response to determining that any analyzed change in a perceptual property in the original audio section is greater than the preset threshold variance (i.e., determination block 708=“Yes”), the wireless device processor may identify a shorter sub-section of the original audio section that contains a next point of such variance (i.e., point at which change in a perceptual property was greater than the preset threshold) in block 710. In block 712, the wireless device processor may analyze the changes in the perceptual properties across the shorter sub-section. In determination block 714, the wireless device processor may determine whether there is another analyzed change(s) in a perceptual property greater than the preset threshold variance (e.g., from determination block 708). In response to determining that there is another analyzed change(s) greater than the preset threshold variance (i.e., determination block 714=“Yes”), the wireless device processor may repeat the operations in blocks 710-712. That is, for each next point of variance greater than the preset threshold, the wireless device processor may analyze a shorter subsection.

In response to determining that no analyzed change in a perceptual property in the original audio section is greater than the preset threshold variance (i.e., determination block 708=“No”), and/or determining that there is no other analyzed change(s) greater than the preset threshold variance (i.e., determination block 714=“No”), the wireless device processor may periodically sample perceptual properties (e.g., volume, pitch, tempo, etc.) of the original audio section using a preset or dynamically selected sampling interval in block 716. In block 718, the wireless device processor may measure the duration of a new audio section. In some embodiments, the new audio section may be the selected best substitute subject matter from block 526, or a synthesized base sequence from block 530 (FIG. 5B).

In some embodiments, the new audio section may be a replacement sequence created in block 528, which may be undergoing further adjustment/modification prior to or as part of integration into the buffered audio data. In block 720, the wireless device processor may stretch or shrink the new audio section to match the duration of the original audio section. For example, the wireless device processor may insert and/or remove non-speech in-between words, increase or decrease a time interval for playing a fixed tempo portion, etc. In block 722, the wireless device processor may increase and/or decrease perceptual property values (e.g., pitch, volume, tempo, etc.) in the new audio section to line up with the corresponding the periodic samples of the original audio section (from block 718). In block 724 the wireless device processor may remove speech from the original audio section. That is, the wireless device processor may remove audio data that is in the human speech frequency range, thereby leaving just non-speech (i.e., background) noise. In optional block 726, the wireless device processor may remove non-speech noise from the new audio section when needed. For example, such removal may be needed when the new audio section is substitute subject matter, whereas removal of non-speech noise is not needed when the new audio data is a synthesized base sequence. In block 728, the wireless device processor may combine the original audio section with the new audio section.

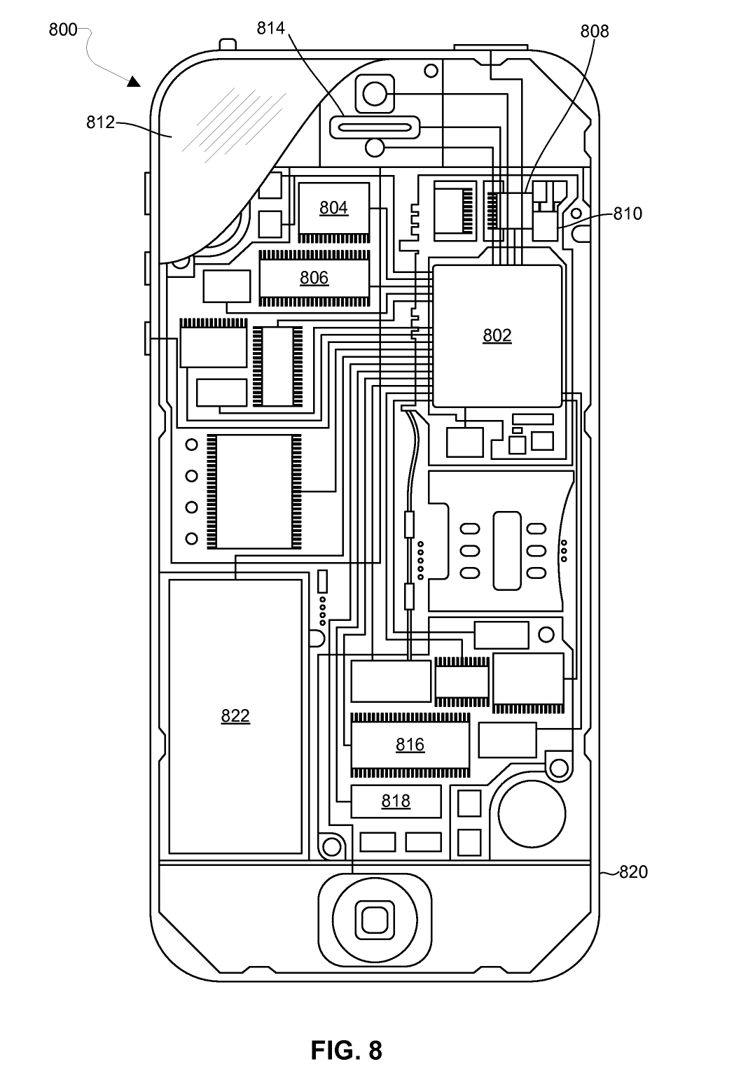

Various embodiments may be implemented in any of a variety of wireless devices, an example of which is illustrated in FIG. 8. For example, with reference to FIGS. 1-8, a wireless device 800 (which may correspond, for example, to the wireless devices 102, 200 in FIGS. 1-2) may include a processor 802 coupled to a touchscreen controller 804 and an internal memory 806. The processor 802 may be one or more multicore integrated circuits (ICs) designated for general or specific processing tasks. The internal memory 806 may be volatile or non-volatile memory, and may also be secure and/or encrypted memory, or unsecure and/or unencrypted memory, or any combination thereof.

The touchscreen controller 804 and the processor 802 may also be coupled to a touchscreen panel 812, such as a resistive-sensing touchscreen, capacitive-sensing touchscreen, infrared sensing touchscreen, etc. The wireless device 800 may have one or more radio signal transceivers 808 (e.g., Peanut®, Bluetooth®, Zigbee®, Wi-Fi, RF radio) and antennae 810, for sending and receiving, coupled to each other and/or to the processor 802. The transceivers 808 and antennae 810 may be used with the above-mentioned circuitry to implement the various wireless transmission protocol stacks and interfaces. The wireless device 800 may include a cellular network wireless modem chip 816 that enables communication via a cellular network and is coupled to the processor. The wireless device 800 may include a peripheral device connection interface 818 coupled to the processor 802. The peripheral device connection interface 818 may be singularly configured to accept one type of connection, or multiply configured to accept various types of physical and communication connections, common or proprietary, such as USB, FireWire, Thunderbolt, or PCIe. The peripheral device connection interface 818 may also be coupled to a similarly configured peripheral device connection port (not shown). The wireless device 800 may also include speakers 814 for providing audio outputs. The wireless device 800 may also include a housing 820, constructed of a plastic, metal, or a combination of materials, for containing all or some of the components discussed herein. The wireless device 800 may include a power source 822 coupled to the processor 802, such as a disposable or rechargeable battery. The rechargeable battery may also be coupled to the peripheral device connection port to receive a charging current from a source external to the wireless device 800.

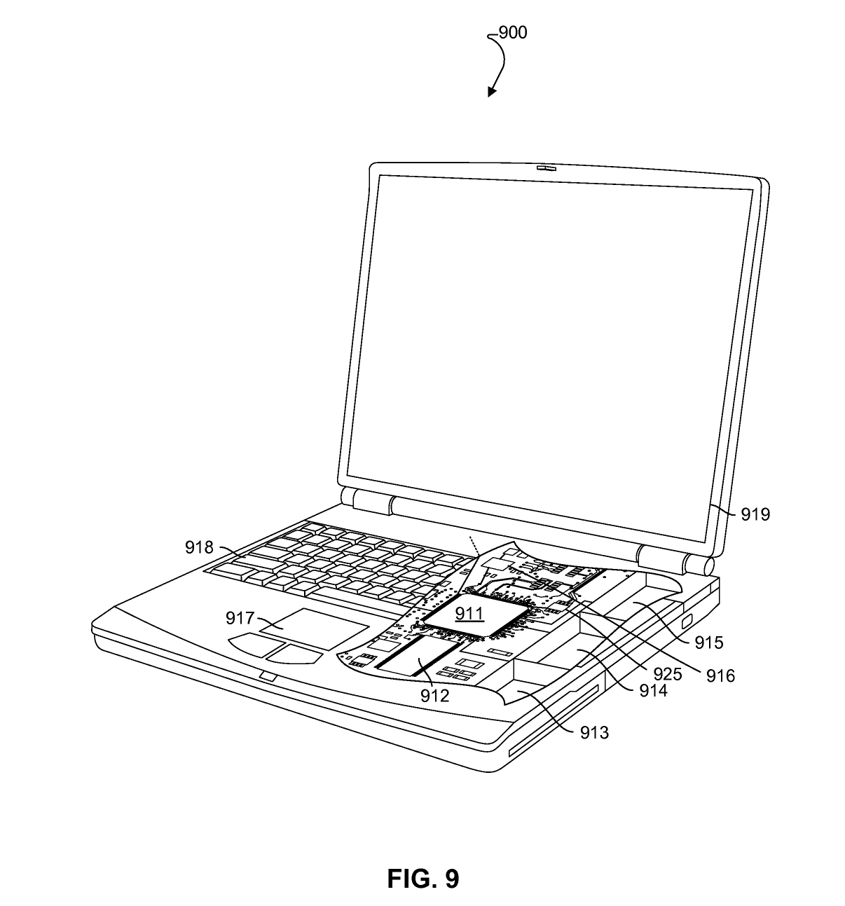

Various embodiments described above may also be implemented within a variety of personal computing devices, such as a laptop computer 900 (which may correspond, for example, the wireless devices 102, 200 in FIGS. 1-2) as illustrated in FIG. 9. With reference to FIGS. 1-9, many laptop computers include a touchpad touch surface 917 that serves as the computer's pointing device, and thus may receive drag, scroll, and flick gestures similar to those implemented on wireless computing devices equipped with a touch screen display and described above. The laptop computer 900 will typically include a processor 911 coupled to volatile memory 912 and a large capacity nonvolatile memory, such as a disk drive 913 of Flash memory. The laptop computer 900 may also include a floppy disc drive 914 and a compact disc (CD) drive 915 coupled to the processor 911. The laptop computer 900 may also include a number of connector ports coupled to the processor 911 for establishing data connections or receiving external memory devices, such as a USB or FireWire® connector sockets, or other network connection circuits for coupling the processor 911 to a network. In a notebook configuration, the computer housing includes the touchpad touch surface 917, the keyboard 918, and the display 919 all coupled to the processor 911. Other configurations of the computing device may include a computer mouse or trackball coupled to the processor (e.g., via a USB input) as are well known, which may also be use in conjunction with various embodiments.

The processors 802 and 911 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 806, 912 and 913 before they are accessed and loaded into the processors 802 and 911. The processors 802 and 911 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 802, 911, including internal memory or removable memory plugged into the device and memory within the processor 802 and 911, themselves.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of processing received media content to generate a personalized presentation on an end point device, comprising:
buffering the received media content in a moving window buffer;
creating tokens from the received media content by:
parsing a next content element; and
for each content element, identifying a speaker or actor, creating a text representation of the content element, and measuring perceptual properties of the content element, wherein the perceptual properties comprise at least one of acoustic characteristics of a voice of the identified speaker or actor or visual characteristics;
comparing tokens in a segment within the buffered media content to a list of replacement subject matter associated with a user profile to determine whether the segment matches any of the replacement subject matter; and
in response to determining that the segment matches any of the replacement subject matter:
identifying substitute subject matter for the matched replacement subject matter;
determining whether a replacement database contains any of the identified substitute subject matter;
in response to determining that the replacement database contains any of the identified substitute subject matter:
selecting a best substitute subject matter based on properties of tokens in the segment; and
creating a replacement sequence by modifying the selected best substitute subject matter using the perceptual properties of the tokens in the segment;
integrating the replacement sequence with the buffered media content for the user profile; and
rendering a personalized media presentation corresponding to the user profile, wherein the personalized media presentation includes the integrated replacement sequence.

2. The method of claim 1, wherein acoustic characteristics of the voice of the identified speaker or actor comprise one or more of pitch, timbre, volume, and timing.

3. The method of claim 1, wherein visual characteristics include one or more of frame rate, content-based motion, egomotion, optical flow, lighting, color, texture, topological features, and pose estimations.

4. The method of claim 1, further comprising
synthesizing the replacement sequence based on the identified substitute subject matter and the perceptual properties of the tokens in the segment in response to determining that the segment does not match any of the replacement subject matter.

5. The method of claim 1, further comprising dynamically developing the replacement database from received media content by storing in the replacement database one or more tokens that are created, wherein storing one or more tokens comprises maintaining a local copy of the parsed content element with corresponding speaker or actor, text representation, and perceptual properties.

6. The method of claim 1, further comprising:
comparing each created token or segment comprising tokens to a list of target subject matter associated with the user profile or with the received media content, wherein the list of target subject matter comprises at least one of:
a list of the substitute subject matter generated by a user and associated with a type of audience; and
a list of significant attributes, phrases, or scenes associated with the received media content;
determining whether the token or segment comprising tokens matches any of the target subject matter; and
storing the token or segment comprising tokens in the replacement database in response to determining that the token or segment matches any of the target subject matter.

7. The method of claim 1, wherein selecting the best substitute subject matter is based on one of:
the perceptual properties of the tokens in the segment; and
a pre-set ranking selected by a user of the end point device.

8. The method of claim 1, wherein the content elements comprise at least one of phonemes, words, phrases, sentences, scenes, and frames.

9. The method of claim 1, wherein:
creating tokens from the received media content comprises creating tokens from an audio stream; and
creating the text representation for each content element comprises applying speech-to-text conversion to the content element.

10. The method of claim 1, wherein:
creating tokens from the received media content comprises creating tokens from a video stream; and
creating the text representation for each content element comprises:
applying object recognition to the content element; and
generating a description of recognized objects in the content element.

11. The method of claim 1, further comprising determining whether the segment matches any of the replacement subject matter based on at least one of:
the text representations for tokens within the segment; and
the identified speaker or actor for tokens within the segment.

12. The method of claim 1, further comprising:
recognizing an audience viewing or hearing the rendered media; and
selecting the user profile corresponding to the recognized audience viewing or hearing the rendered media, wherein the list of replacement subject matter is based on the selected user profile.

13. The method of claim 1, wherein identifying the speaker or actor comprises:
retrieving, from metadata of the received media content, an identification of a title for the received media content;
accessing at least one third party database; and
searching the at least one third party database based on the retrieved title.

14. The method of claim 1, further comprising:
accessing at least one media database to identify content sources for the identified speaker or actor;
searching the at least one media database for samples of the identified content sources; and
creating supplemental tokens corresponding to the identified speaker or actor by:
applying the voice or image recognition to the samples;
parsing content elements from the recognized samples; and
creating text representations and measuring perceptual properties of the parsed content elements,
wherein the supplemental tokens are stored in the replacement database such that the stored supplemental tokens are associated with the identified speaker or actor.

15. A computing device, comprising:
a memory;
receiver circuitry configured to receive media content from a source; and
a processor coupled to the memory and the receiver circuitry and configured with processor-executable instructions to perform operations comprising:
buffering received media content in a moving window buffer;
creating tokens from the received media content by:
parsing a next content element; and
for each content element, identifying a speaker or actor, creating a text representation of the content element, and measuring perceptual properties of the content element, wherein the perceptual properties comprise at least one of acoustic characteristics of a voice of the identified speaker or actor or visual characteristics;
comparing tokens in a segment within the buffered media content to a list of replacement subject matter associated with a user profile to determine whether the segment matches any of the replacement subject matter; and
in response to determining that the segment matches any of the replacement subject matter:
identifying substitute subject matter for the matched replacement subject matter;
determining whether a replacement database contains any of the identified substitute subject matter;
in response to determining that the replacement database contains any of the identified substitute subject matter:
selecting a best substitute subject matter based on properties of the tokens in the segment; and
creating a replacement sequence by modifying the selected best substitute subject matter using the perceptual properties of the tokens in the segment;
integrating the replacement sequence with the buffered media content for the user profile; and
rendering a personalized media presentation corresponding to the user profile, wherein the personalized media presentation includes the integrated replacement sequence.

16. The computing device of claim 15, wherein the processor is configured with processor-executable instructions to perform operations such that acoustic characteristics of a voice of the identified speaker or actor comprise one or more of pitch, timbre, volume, and timing.

17. The computing device of claim 15, wherein the processor is configured with processor-executable instructions to perform operations such that visual characteristics include one or more of frame rate, content-based motion, egomotion, optical flow, lighting, color, texture, topological features, and pose estimations.

18. The computing device of claim 15, wherein the processor is configured with processor-executable instructions to perform operations further comprising
synthesizing the replacement sequence based on the identified substitute subject matter and the perceptual properties of the tokens in the segment in response to determining that the segment does not match any of the replacement subject matter.

19. The computing device of claim 15, wherein the processor is configured with processor-executable instructions to perform operations further comprising dynamically developing the replacement database from received media content by storing in the replacement database one or more tokens that are created, wherein storing one or more tokens comprises maintaining a local copy of the parsed content element with corresponding speaker or actor, text representation, and perceptual properties.

20. The computing device of claim 15, wherein the processor is configured with processor-executable instructions to perform operations further comprising:
comparing each created token or segment comprising tokens to a list of target subject matter associated with the user profile or with the received media content, wherein the list of target subject matter comprises at least one of:
a list of the substitute subject matter generated by a user and associated with a type of audience; and
a list of significant attributes, phrases, or scenes associated with the received media content;
determining whether the token or segment comprising tokens matches any of the target subject matter; and
storing the token or segment comprising tokens in the replacement database in response to determining that the token or segment matches any of the target subject matter.

21. The computing device of claim 15, wherein the processor is configured with processor-executable instructions to perform operations such that selecting the best substitute subject matter is based on one of:
the perceptual properties of the tokens in the segment; and
a pre-set ranking selected by a user of the computing device.

22. The computing device of claim 15, wherein the processor is configured with processor-executable instructions to perform operations such that the content elements comprise at least one of phonemes, words, phrases, sentences, scenes, and frames.

23. The computing device of claim 15, wherein the processor is configured with processor-executable instructions to perform operations such that:
creating tokens from the received media content comprises creating tokens from an audio stream; and
creating the text representation for each content element comprises applying speech-to-text conversion to the content element.

24. The computing device of claim 15, wherein the processor is configured with processor-executable instructions to perform operations such that:
creating tokens from the received media content comprises creating tokens from a video stream; and
creating the text representation for each content element comprises:
applying object recognition to the content element; and
generating a description of recognized objects in the content element.

25. The computing device of claim 15, wherein the processor is configured with processor-executable instructions to perform operations further comprising determining whether the segment matches any of the replacement subject matter based on at least one of:
the text representations for tokens within the segment; and
the identified speaker or actor for tokens within the segment.

26. The computing device of claim 15, wherein the processor is configured with processor-executable instructions to perform operations further comprising:
recognizing an audience viewing or hearing the rendered media; and
selecting the user profile corresponding to the recognized audience viewing or hearing the rendered media, wherein the list of replacement subject matter is based on the selected user profile.

27. The computing device of claim 15, wherein the processor is configured with processor-executable instructions to perform operations such that identifying the speaker or actor comprises:
retrieving, from metadata of the received media content, an identification of a title for the received media content;
accessing at least one third party database; and
searching the at least one third party database based on the retrieved title.

28. The computing device of claim 15, wherein the processor is configured with processor-executable instructions to perform operations further comprising:
accessing at least one media database to identify content sources for the identified speaker or actor;
searching the at least one media database for samples of the identified content sources; and
creating supplemental tokens corresponding to the identified speaker or actor by:
applying a voice or image recognition to the samples;
parsing content elements from the recognized samples; and
creating text representations and measuring perceptual properties of the parsed content elements,
wherein the supplemental tokens are stored in the replacement database such that the stored supplemental tokens are associated with the identified speaker or actor.

29. A computing device, comprising:
means for buffering received media content in a moving window buffer;
means for creating tokens from the received media content comprising:
means for parsing a next content element; and
means for identifying a speaker or actor, creating a text representation of the content element, and measuring perceptual properties for each content element, wherein the perceptual properties comprise at least one of acoustic characteristics of a voice of the identified speaker or actor or visual characteristics;
means for comparing tokens in a segment within the buffered media content to a list of replacement subject matter associated with a user profile to determine whether the segment matches any of the replacement subject matter; and
means for identifying substitute subject matter for the matched replacement subject matter in response to determining that the segment matches any of the replacement subject matter;
means for determining whether a replacement database contains any of the identified substitute subject matter;
means for selecting a best substitute subject matter based on properties of the tokens in the segment in response to determining that the replacement database contains any of the identified substitute subject matter;
means for creating a replacement sequence by modifying the selected best substitute subject matter using the perceptual properties of the tokens in the segment;
means for integrating the replacement sequence with the buffered media content for the user profile; and
means for rendering a personalized media presentation corresponding to the user profile, wherein the personalized media presentation includes the integrated replacement sequence.

30. A non-transitory processor-readable storage medium having stored thereon processor-executable instructions configured to cause a processor of a computing device to perform operations comprising:
buffering received media content in a moving window buffer;
creating tokens from the received media content by:
parsing a next content element; and
for each content element, identifying a speaker or actor, creating a text representation of the content element, and measuring perceptual properties of the content element, wherein the perceptual properties comprise at least one of acoustic characteristics of a voice of the identified speaker or actor or visual characteristics;
comparing tokens in a segment within the buffered media content to a list of replacement subject matter associated with a user profile to determine whether the segment matches any of the replacement subject matter; and
in response to determining that the segment matches any of the replacement subject matter:
identifying substitute subject matter for the matched replacement subject matter;
determining whether a replacement database contains any of the identified substitute subject matter;
in response to determining that the replacement database contains any of the identified substitute subject matter:
selecting a best substitute subject matter based on properties of the tokens in the segment; and
creating a replacement sequence by modifying the selected best substitute subject matter using the perceptual properties of the tokens in the segment;
integrating the replacement sequence with the buffered media content for the user profile; and
rendering a personalized media presentation corresponding to the user profile, wherein the personalized media presentation includes the integrated replacement sequence.
